(19) United States
(12) Patent Application Publication
(10) Pub. No.: US 2015/0324547 A1
(43) Pub. Date: Nov. 12, 2015

(54) METHODS AND SYSTEMS FOR PHARMACEUTICAL PRESCRIPTION AUTHORIZATION RULES GENERATION

(71) Applicant: Hearst Communications, Inc., South San Francisco, CA (US)

(72) Inventors: Justin Vogel Graham, Oakland, CA (US); Peter Leonard Abramowitsch, Fairfax, CA (US); William Ryan Berger, Venice, CA (US); Mili Gera, Freemont, CA (US); Polina Tarnopolskaya, Walnut Creek, CA (US); Adrienne Lee White, San Francisco, CA (US)

(21) Appl. No.: 14/702,111

(22) Filed: May 1, 2015

Related U.S. Application Data
(60) Provisional application No. 61/989,345, filed on May 6, 2014.

(51) Int. Cl. G06F 19/00

(52) U.S. Cl. CPC G06F 19/3456

(57) ABSTRACT

A system generates executable prior authorization drug request rules using a compiler. A data repository stores drug criteria. The system is configured to generate a criteria specification user interface that enables a user to specify exclusion criteria, inclusion criteria, preferred or step therapy criteria, concurrent therapy criteria, assessment criteria, quantity limits, and/or refill instructions. A prescription prior authorization rules compiler module is configured to access a criteria specification for the drug from the repository and to automatically compile the criteria specification into executable prescription prior authorization rules. A drug criteria object generation module is configured to generate a drug criteria object for the drug, including drug criteria object identification information, the executable prescription prior authorization rules, a data dictionary, and/or canonical data. A rules engine may be provided with access to the drug criteria object for execution of the prescription prior authorization rules.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field of the Invention

The present invention relates to prescription drug prior authorization systems and methods.

2. Description of the Related Art

In the United States healthcare insurance industry, certain drugs prescribed by physicians will not automatically be covered under a formulary unless a set of criteria are met. The criteria may vary for each drug and the criteria can be very complex.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

A system generates executable prior authorization drug request rules using a compiler. A data repository stores drug criteria. The system is configured to generate a criteria specification user interface that enables a user to specify exclusion criteria, inclusion criteria, preferred or step therapy criteria, concurrent therapy criteria, assessment criteria, quantity limits, and/or refill instructions. A prescription prior authorization rules compiler module is configured to access a criteria specification for the drug from the repository and to automatically compile the criteria specification into executable prescription prior authorization rules. A drug criteria object generation module is configured to generate a drug criteria object for the drug, including drug criteria object identification information, the executable prescription prior authorization rules, a data dictionary, and/or canonical data. A rules engine may be provided with access to the drug criteria object for execution of the prescription prior authorization rules.

An aspect of the disclosure is a system configured to generate prior authorization drug request rules, the system comprising: a computer data repository that stores drug prior authorization criteria for a plurality of drugs; and a computing system comprising one or more computing devices, said computing system programmed to implement: a user interface generation module configured to generate a criteria specification user interface configured to enable a user to specify at least exclusion criteria, inclusion criteria, preferred or step therapy criteria, concurrent therapy criteria, assessment criteria, quantity limits, and refill instructions; a prescription prior authorization rules compiler module configured to access a criteria specification for the drug from the computer data repository and to automatically compile the criteria specification into executable prescription prior authorization rules configured to be executed by a prescription prior authorization rules evaluation engine; a rendering module configured to generate human readable prescription criteria from canonical data included in the criteria specification; a drug criteria object generation module configured to generate a drug criteria object for the drug, including drug criteria object identification information, the executable prescription prior authorization rules, a data dictionary, and canonical data; and/or a search engine configured to search a drug criteria object library in response to a user search query, the user search query including a drug name, an indication, a therapeutic class, or a drug code.

An aspect of the disclosure is a method for generating prior authorization drug request rules, the method comprising: providing by a computer system comprising hardware for display on a user terminal, a user interface comprising a plurality of fields, the plurality of fields configured to receive information regarding a first drug, including at least prescription prior approval criteria for approving a prescription of the first drug, wherein the user interface enables a user to specify inclusion criteria, exclusion criteria, concurrent therapy criteria, and preferred or step therapy criteria; receiving and storing at the computer system prescription prior approval criteria for the first drug specified using the user interface; compiling by the computer system the prescription prior authorization approval criteria into executable prescription prior authorization approval rules code without a user manually coding the executable prescription prior authorization approval rules code; generating by the computer system a self-contained drug criteria object, the self-contained drug criteria object comprising at least: identification information indicating which drug, route, strength, and dosage forms the self-contained drug criteria object refers to, the executable prescription prior authorization approval rules code, a hierarchical data dictionary, canonical data instantiating concepts of the hierarchical data dictionary, and/or a unique identifier; storing by the computer system the self-contained drug criteria object in non-transitory memory; providing by the computer system a prescription prior authorization approval rules engine with access to the stored self-contained drug criteria object for execution.

An aspect of the disclosure is a computer storage system comprising a non-transitory storage device, the computer storage system having stored thereon executable program instructions that direct a computer system to at least: provide, for display on a user terminal, a user interface comprising a plurality of fields, the plurality of fields configured to receive information regarding a first drug, including at least prescription prior approval criteria for approving a prescription of the first drug, wherein the user interface enables a user to specify inclusion criteria, exclusion criteria, concurrent therapy criteria, and/or preferred/step therapy criteria; receive and store prescription prior approval criteria for the first drug specified using the user interface; compile the prescription prior authorization approval criteria into executable prescription prior authorization approval rules code; generate a drug criteria object, the drug criteria object comprising: identification information indicating which drug, route, strength, and dosage forms the drug criteria object refers to, the executable prescription prior authorization approval rules code, a hierarchical data dictionary, and/or a unique identifier; store the drug criteria object in non-transitory memory; provide a prescription prior authorization approval rules engine with access to the stored drug criteria object for execution.

### BRIEF DESCRIPTION OF THE DRAWINGS

FIG. 1A-1C illustrates an example system environment and certain components thereof.

FIG. 2 illustrates an example drug criteria object generation process.

FIG. 3 illustrates an example executable rules code generation process.

FIG. 4 illustrates an example drug criteria object.

FIGS. 5A-5E illustrate example user interfaces.

### DETAILED DESCRIPTION

In the healthcare insurance industry, certain drugs prescribed by physicians will not automatically be covered under a patient's insurance even if that drug is on the insurance plan's formulary. In order for such prescriptions to be fulfilled, a set of criteria need to be fulfilled and the prescription may need to be preauthorized (e.g., by the payer or his representative). The criteria may vary for each drug and for each disease-state which the drug can be applied to. The criteria may also vary by health plan, even within a single insurance company or payer. Conventionally, given such complexity, highly trained professionals are employed to generate an insurer's guidelines for each covered drug and then use the guidelines to evaluate a given prior authorization prescription request. Such manual evaluation tends to be extremely error prone, slow, and expensive. Further, such conventional approaches are unable to adequately or dynamically adjust to changing criteria, new drug developments, or new procedures.

Certain aspects described herein will enable industry to keep up with the hundreds of millions of prescriptions created annually, by providing an authoring and authorization system configured to efficiently capture and represent such criteria. Further, the disclosed system enables such criteria to be captured and processed in a form that is adaptable to multiple insurance and service providers in many different health care contexts. The disclosed system is optionally configured to render such criteria as a set of unambiguous rules for a given drug using a rules compiler.

Thus, techniques disclosed herein provide for more efficient, less error prone, and more comprehensive review and approval processes for medical treatment prescriptions, such as for medication as compared to conventional techniques. Further, certain embodiments reduce network traffic and loading of prescription authorization systems by such efficient processing.

Optionally, standardized reference criteria are provided that may be used by a prescription approval system (e.g., authoring and authorization system 102 discussed below) in determining whether or not to provide prior authorization for a prescription, such as a prescription issued by a doctor, or whether to fulfill a prescription when at the point of dispensing. Thus, for example, a given drug may be described by a finite set of criteria types that are described in an information model (e.g., a prior authorization criteria object). The criteria may optionally be enumerated in a document (e.g., in an XML (eXtensible Markup Language) file, in a JSON (JavaScript Object Notation) file, other lightweight data-interchange format, and/or other language file) as metadata definitions of concepts which will be used in a rule. The document may be an optional intermediate document, which may then be compiled into executable rules object code (which may be in the form of a human readable computer language or a machine code language). The language used may be one that is relatively easy for a human to read and understand. The prior authorization criterion object may be compiled into a set of prior authorization rules. Optionally, the prior authorization criterion object may be transformed into an electronic National Council for Prescription Drug Programs, (NCPDP) Script Prior Authorization Initiation Response, or an electronic Prior Authorization Request, where NCPDP is an ANSI-accredited, standards development organization providing healthcare solutions.

As will be discussed in greater detail herein, a system may include some or all of the following: a rules engine configured to execute drug prescription authorization rules, a rules compiler (e.g., a drug prescription authorization rules compiler), a prescription authorization criterion object library (sometimes referred to herein as a drug library), a form renderer, a decision tree renderer, and interfaces to other systems (e.g., to physician, hospital, insurance, pharmacist, government, and/or other systems). A renderer module may be provided which turns structured, granular data into a human understandable language (e.g., English or other natural language) or which may translate executable rules into a form that may be understood by a non-programmer. For example, the renderer module may report a rule violation which prevents approval of a prescription for a patient (“patient has not taken drug A, B, C in last 3 years”). The renderer module may also generate various forms, such as prior authorization forms. Certain embodiments may be implemented as a stand-alone system, while certain other embodiments may be configured to connect to an electronic prior authorization workflow system and/or an insurance claims adjudication system.

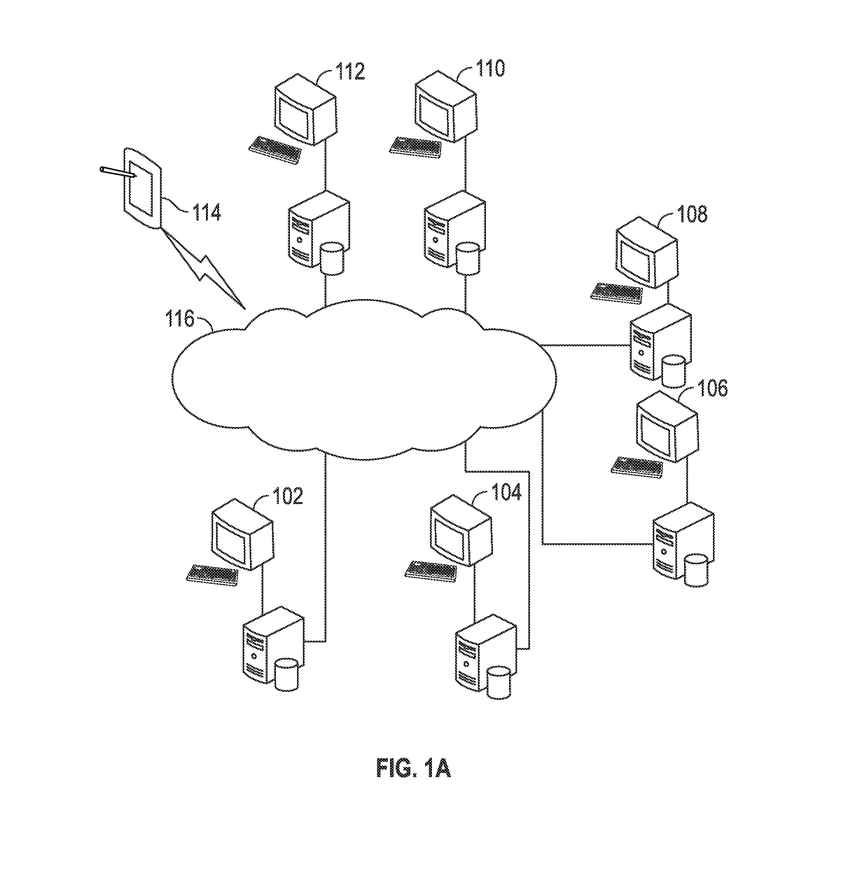

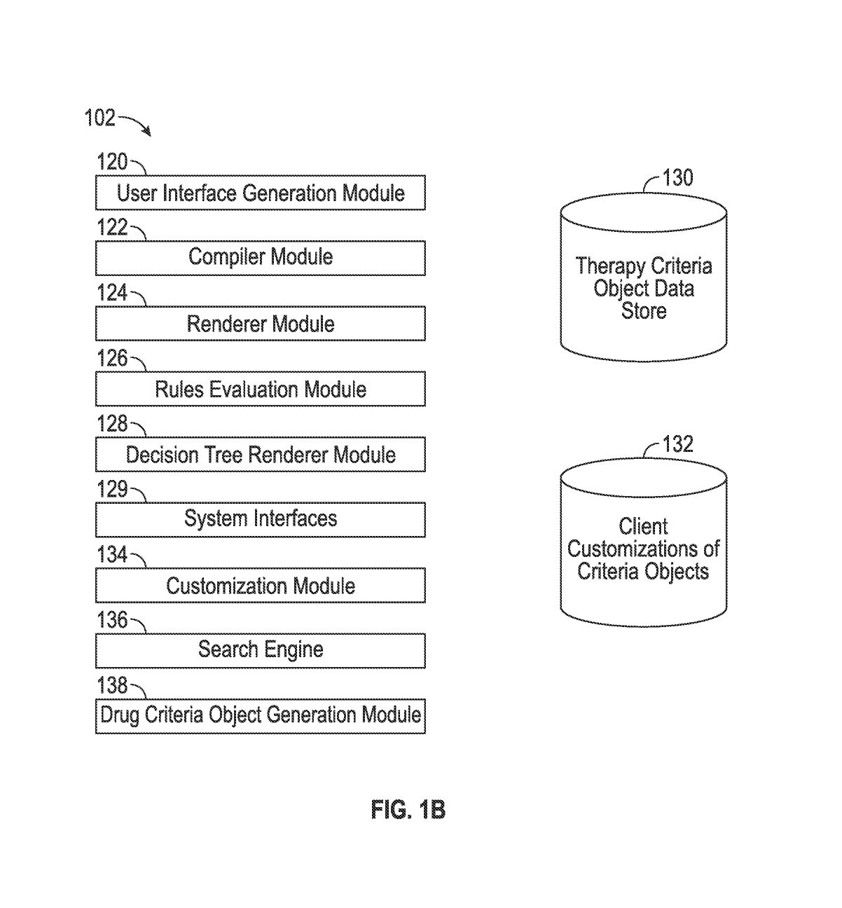

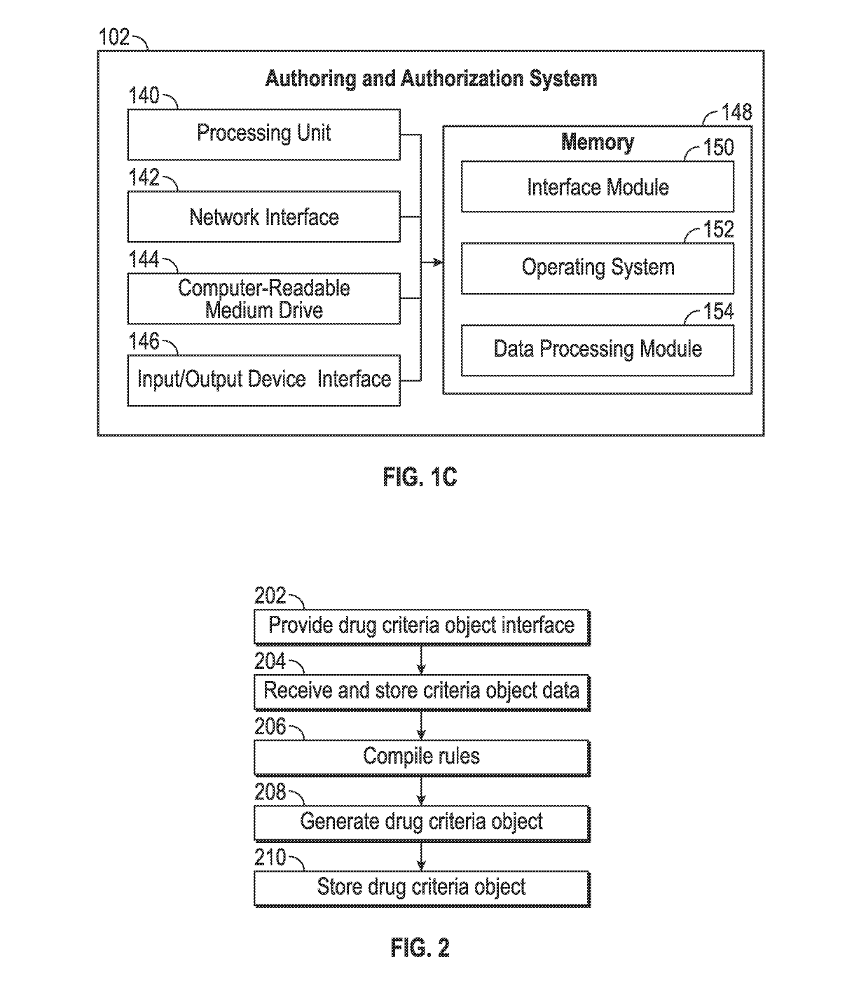

For example, with reference to FIGS. 1A-1C, an authoring and authorization system 102 may communicate over a network 116 (e.g., the Internet, a private networks, a local area network, a wireless network, or any combination of the foregoing) to one or more physician systems 104, hospital systems 106, insurance company systems 108, pharmacist systems 110, government systems 112, patient systems 114, and/or other systems. The various systems may include data stores 130, 132 comprising databases that store therapy (e.g., drug) criteria objects (which may be utilized as customizable drug criteria objects), client customized criteria objects, templates, drug data, patient data, clinical data, insurance formulary data, and/or other data.

Referring to FIG. 1B, the authoring and authorization system 102 may include various modules providing various services. For example, the authoring and authorization system 102 may include some or all of the following: a user interface generation module 120 that may be configured to generate the various interfaces (including forms) described herein and/or other interfaces; a compiler module 112 configured to compile knowledge encoded in a prescription authorization criterion object into executable rules (e.g., the compiler module 112 may analyze a criteria data document, identify dependences and links of various elements, and generate rules accordingly); a render module 124 configured to convert structured, granular data into a human understandable language and/or or which may translate executable rules into a form that may be understood by a non-programmer; a rules evaluation module 126 (sometimes referred to herein as a rules engine) configured to execute the rules generated by the compiler module and to determine whether a prescription is to be approved; a decision tree renderer module 128 configured to generate a decision tree that provides a graphical representation of rules for user viewing (e.g., to display a graphical representation of the adjudication process); interfaces 129 (e.g., application programming interfaces, database interfaces, etc.) to enable communication and data exchanges with one or more other systems, such as systems 104-114. It is understood that various modules may be hosted on different systems operated by different entities. For example, the user interface generation module 120, the compiler module 112, and the renderer module 124 may be hosted on a first system operated by a first entity (e.g., an entity that develops at least an initial version of drug criteria objects) and the rule evaluation module 126 may be hosted on a second system operated by a second entity (e.g., an health insurance company, pharmacy benefit manager, or government entity). Further, one or more of the modules may be duplicated on two or more systems operated by the same or different entities. Examples of the various components of system 102 are described in greater detail elsewhere herein.

Referring to FIG. 1C, the example authoring and authorization system 102 includes a processing unit 140, a network interface 142, a non-transitory computer-readable medium drive 144, and an input/output device interface 146, all of which may communicate with one another by way of a communication bus. The network interface 142 may provide the authoring and authorization system 102 with connectivity to one or more networks (e.g., network 116) or computing systems. The processing unit 140 may thus receive information and instructions from other computing devices, systems, or services, such as systems 104-114, via the network 116. The processing unit 140 may also communicate to and from memory 148 and further provide output information via the input/output device interface 146. The input/output device interface 146 may also accept input from various input devices, such as a keyboard, mouse, digital pen, touch screen, etc.

The memory 148 may contain computer program instructions that the processing unit 140 may execute in order to implement one or more embodiments of the present disclosure. The memory 148 generally includes RAM and ROM and/or other persistent or non-transitory computer-readable storage media. The memory 148 may store an operating system 152 that provides computer program instructions for use by the processing unit 140 in the general administration and operation of the authoring and authorization system 102. The memory 148 may further include other information for implementing aspects of the present disclosure.

Optionally, the memory 148 includes an interface module 150. The interface module 150 can be configured to facilitate generating one or more interfaces through which a third party user, utilizing a compatible computing device, may send to, or receive from, the authoring and authorization system 102 data (such as patient data, drug data, insurance data, authorization data), or otherwise communicate with the authoring and authorization system 102. Specifically, the interface module 146 may be configured to facilitate processing functions described herein.

In addition, the memory 148 may include a data processing module 154 that may be executed by the processing unit 140. Optionally, the data processing module 154 implements aspects of the present disclosure. For example, the data processing module 154 can be configured to process queries, instructions, data and content from the data stores 130, 132, etc.

Optionally, a customization module 134 enables multiple versions of a given drug criteria object to be created and edited for respective multiple formularies and/or lines of business (e.g., by different insurance companies or governmental entities). For example, the customization module may enable an operator to copy a drug criteria object, edit and customize the copied drug criteria object, and store the customized drug criteria object, with a unique identifier, in a data store, such as data client customization data store 132. The customized drug criteria object may be stored in association with an account identifier of an entity that created or will use the customized drug criteria object.

A search engine 136 may be provided enabling a user to search the drug library/drug criteria object library by drug name (e.g., by generic name, by brand name, formulary name, by alternate name), class, indications, code, and/or by one or more other fields, such as those fields disclosed herein. A drug criteria object generation module 138 may be provided that generates a drug criteria object. For example, the drug criteria object generation module 138 may include some or all of the drug criteria object information disclosed herein (e.g., some or all of the following: a header, compiled executable rules, drug prescription preapproval criteria entered via a user interface or accessed from a data store, a data dictionary, canonical data, patient data, lists, therapeutic alternatives, etc.). The drug criteria object generation module 138 may store the drug criteria object in the data store 130.

For example, optionally, a prescription authorization system enables a give user entity, such as an insurance company or a prescription management entity (which may be a government management entity, such as Medicare), to customize the criteria and/or add alternative treatments (e.g., alternative formularies that may be more cost effective). Optionally, the user entity may customize criteria for different insurance plans. Thus, a given user entity may have several sets of customized criteria which may be respectively applied to corresponding prescriptions under a given insurance plan or formulary. By way of illustration, an insurer may add a requirement that the prescriber must provide a recent record of a value for a specific laboratory parameter (e.g., white blood cell count) as one of the prerequisites for preapproval of the prescription. By way of further illustration, if a given reference set of criteria specifies that a patient needs to have a particular condition in order to approve a drug for prior authorization, but a given insurance plan has the additional requirement that other therapeutically-equivalent medications need to be attempted first to treat the particular condition, the insurance plan user may customize the core reference criteria set to add this additional rule.

The criteria are constructed of concepts that may be normalized to standard terminologies in several clinical domains, may be electronically linked to related clinical references, may be customizable to reflect organizational policies, may be updated when new data is released, and/or may be used to generate prior authorization (PA) forms that are compliant with existing and new electronic PA standards.

Optionally, a change in criteria may need to be processed in accordance with a workflow approval process managed by the system. The system may track and report the status of the approval process (e.g., change is in review, is approved, or has been approved and is published). Different users may be assigned different roles and have different levels of authorization to make and/or approve changes. For example, a pharmacy clinical manager may be assigned the role of “user entity author,” while an author/pharmacist associated with the provider of the system or system software may be assigned the role of “provider author”. In addition, other users may be assigned the role of user entity or provider super-user with enhanced rights to edit, manage, and approve content or changes thereto. The system may maintain records of changes (e.g., identifying a drug criteria object that has been edited, who performed the edit, when (e.g., date and time) the edit was performed, what was edited), and version records for a given drug criteria object.

The system may be configured to generate paper reports and/or electronic reports that may be exported to and ingested by other systems (e.g., hospital, pharmacy, and/or physician systems).

The system may provide a standardized library of questions which may need be to be responded (e.g., by the prescribing physician) in order for a given prescription to be approved.

The system may provide analytics and treatment related information and provide corresponding alerts and reports to users. For example, the system may be configured to monitor, detect, and report drug alerts, how many new drugs have been approved for a certain use, new uses for an existing drug, cost of alternative therapies for a given therapies, trends in the amount of a given drug being prescribed for a given use, changes in warnings related to drug usage, the status of criteria, workload ratings of those involved in the criteria approval process and/or the prescription approval process, pharmacy news, etc. By way of further example, the system may track and report what different users are using as criteria, what drugs are covered by which insurance plans, etc. The report may be filtered to provide a given user entity data for other similarly situated user entities, such as for health plans of a similar size and/or covering a similar population (e.g., in terms of age, disease, geographical region, etc.).

As noted above, the system optionally includes a rules compiler that encodes knowledge such as the drug authorization criteria discussed herein. The rules compiler may be used to define ways of specifying therapies in logical constructs that can be evaluated by the system. A criterion object may be generated that encapsulates some or all of the following: the clinical knowledge, the display configuration for authoring, evaluable rules logic, the instance level data of an authorization for a specific drug for a specific patient such that the object can be used for adjudication purposes, or for instrumentation of a third party system that implements prior authorization workflow. The criterion object may comprise a complex object graph containing its own data dictionary and sufficient metadata such that it can be validated for internal consistency without reference to outside metadata sources. Thus, the example criterion object, being self-contained, is therefore portable across systems and across successive updates of the underlying platform.

For example, the system may include a pre-populated criteria library (e.g., an evidenced based drug library, including such information as drug brand name, generic name, version, therapeutic alternatives, class indications, status, date/time record was last updated, etc.), which may be normalized to standard terminology, and which may be electronically linked to clinical references (e.g., relevant electronic articles or books that are based on medical research and reflect clinical evidence and/or best practices, where user activation of a link causes the corresponding clinical reference to be accessed from a data store and presented to the user on the user terminal). As noted above, different entities, such as different insurance companies or governmental entities, may customize a given prescription authorization criterion object, and the system may store such customized prescription authorization criterion object in association with an identifier for the customizing entity, for later retrieval and use (e.g., in data store 132). For example, an entity may use a predefined prescription authorization criterion object as a template (e.g., for starter criteria), and the entity may add or modify conditions for approval or disapproval for the drug.

Thus, there may be one or more generations and instantiations of a given drug criteria object. For example, a first generation of a given drug criteria object may include enough information to publish to a client or to create a form (e.g., an electronic form). A second generation may be edited and the criteria customized for a particular health plan. A third generation of the given drug criteria may optionally be customized to include data for a particular patient. Optionally, a new instance may be created for each new prescription and/or for each renewal of a prescription. For example, a drug criteria object may be modified to include patient details for patient adjudication. When a drug criteria object has been instantiated for a specific patient and prescription, and then used for evaluation, it can be archived as an auditable record of the adjudication with all of the eligibility data and intermediate findings which support the outcome of the adjudication.

Thus, the system may enable a user, such as a pharmacy clinical manager, to learn about new drugs and have access to starter criteria for such drugs in a timely manner, use decision tree logic to make coverage and Pharmaceutical and Therapeutics (P&T) decisions, access PA (Prior Authorization) drug information (e.g., authorization criteria) across the authoring life cycle, generate various types of medication oversight forms (PA (Prior Authorization), ST (Step Therapy), QL (Quantity Limits), Medicare, etc.), and/or schedule medical tests if such have not yet been performed and are needed prior to authorizing a prescription for the prescribed drug. Further, the system may enable the customization of the coverage criteria and processes, understanding coverage criteria practices of other organizations, understanding and accessing exceptions to the criteria, auditing of the use of and edits to PA information, double entry of complex information, and/or efficient PA lifecycle management.

As discussed elsewhere herein, the system optionally enables prescription criteria for a drug, to be highly or completely specified in a structured format (e.g., a highly structured format, such as a prescription authorization criterion object), enabling the criteria to be used to create numerous products that are semantically aligned and do not lose that coherence as the drug information is modified and refined over time.

For example, a prescription authorization criterion object may be used by the system to generate one or more of the following:

1. A human readable summary (e.g., readable by the entity paying for at least a portion of the prescription, such as an insurance company or government entity).

2. A decision tree human readable by an adjudication entity (e.g., that determines, in whole or in part, as to whether to approve the prescription)

3. An authorization form for the provider (e.g., a doctor, other medical professional, etc.), such as an electronic pharmacy prior authorization approval form compatible with ePA standards.

4. A business to business message (e.g., an XML B2B message in a standard format)

5. Executable rules structures that can dynamically facilitate drug authorization.

Conventional rules engines typically need to be programmed by specialists who encode the knowledge and implied logic into a dedicated rules language. By contrast, the system disclosed herein optionally generates these knowledge structures directly from input provided by an entity (e.g., pharmacists, such as a pharmacy clinical manager) without requiring a manual software coding state. The system may include a rules engine which may be dedicated to processing knowledge encoded in a prescription authorization criterion object. The rules engine is configured to traverse rule structures and invoke the behavior needed for the different use cases. Optionally (e.g., where there is no embedded rules engine), the executable rules structures may be the input to an automated translation mechanism which translates the executable rules structures into the rules language of a target engine, and here too, the manual process of creating rules for the target system will have been avoided.

Optionally, as noted above, the system may include a rule writing module (e.g., a rules compiler) to compile the knowledge encoded in a prescription authorization criterion object (which may act as the source code) into computer executable code comprising one or more rules structures. Optionally, the complier may be executed in substantially real time in response to a user (e.g., a content author) entering or updating clinical content, and optionally in response to the user activating a rules generation control. Thus, the rules are optionally created substantially immediately after the raw criteria data for a drug are entered or imported into the system. Such automatic rules generation process greatly reduces the possibility for transcription errors and greatly speeds up the generation of rules.

Optionally, the compiler may also generate a human readable version of the automatically generated rule that provides a non-programmer with the “sense” of the generated rule. The non-aligned textual evaluations may be disambiguated by mapping tests onto supplied vocabulary codes and vocabulary systems. For example, different hospital systems may use different terms and/or codes for a given procedure. In order to enable rules to quickly query electronic medical record systems and ensure the correct data is being accessed, the system may optionally codes for more than one electronic medical record vocabulary in a given drug criteria object, thereby mapping EMR vocabularies to the system vocabularies.

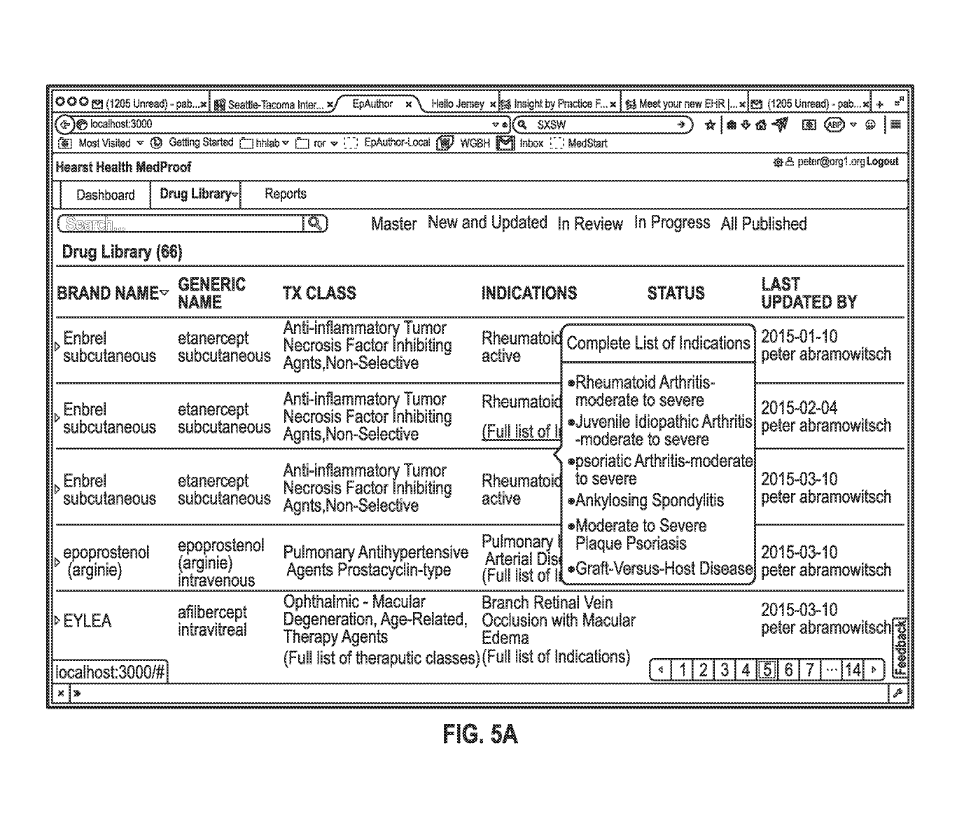

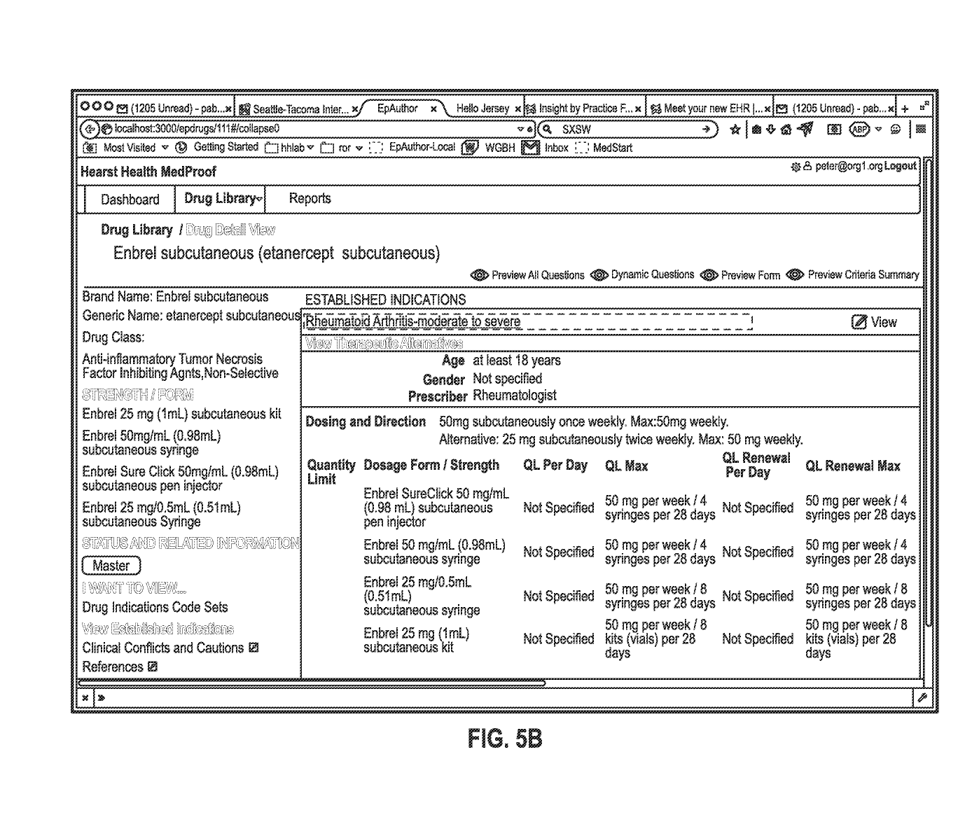

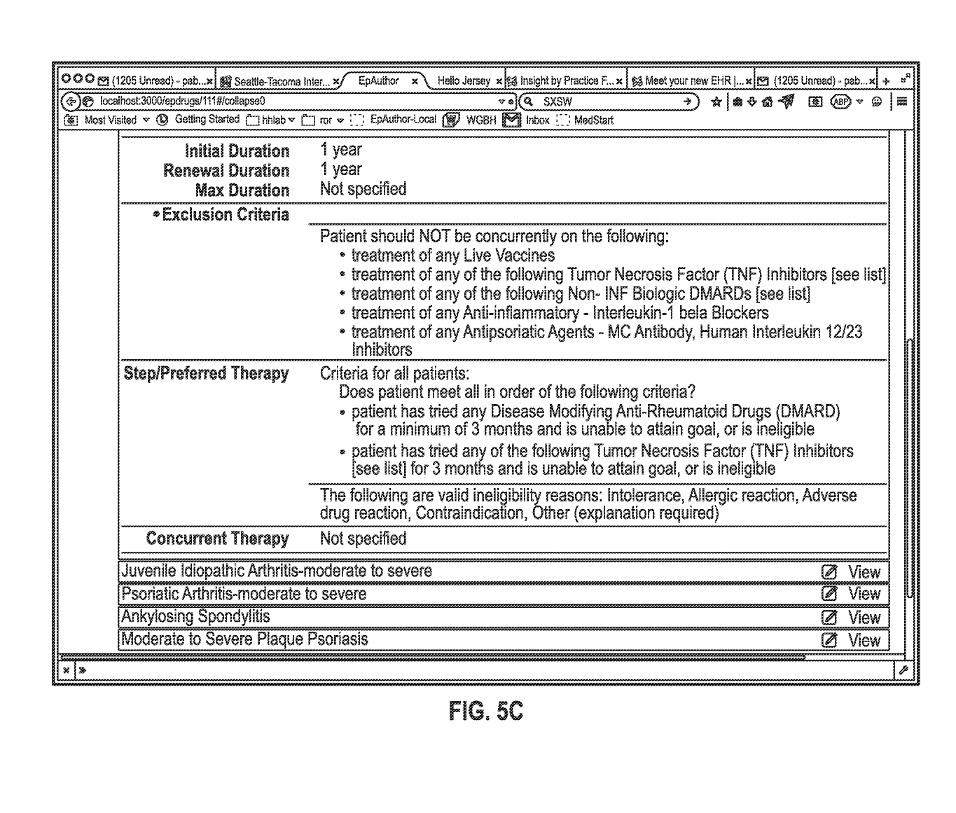

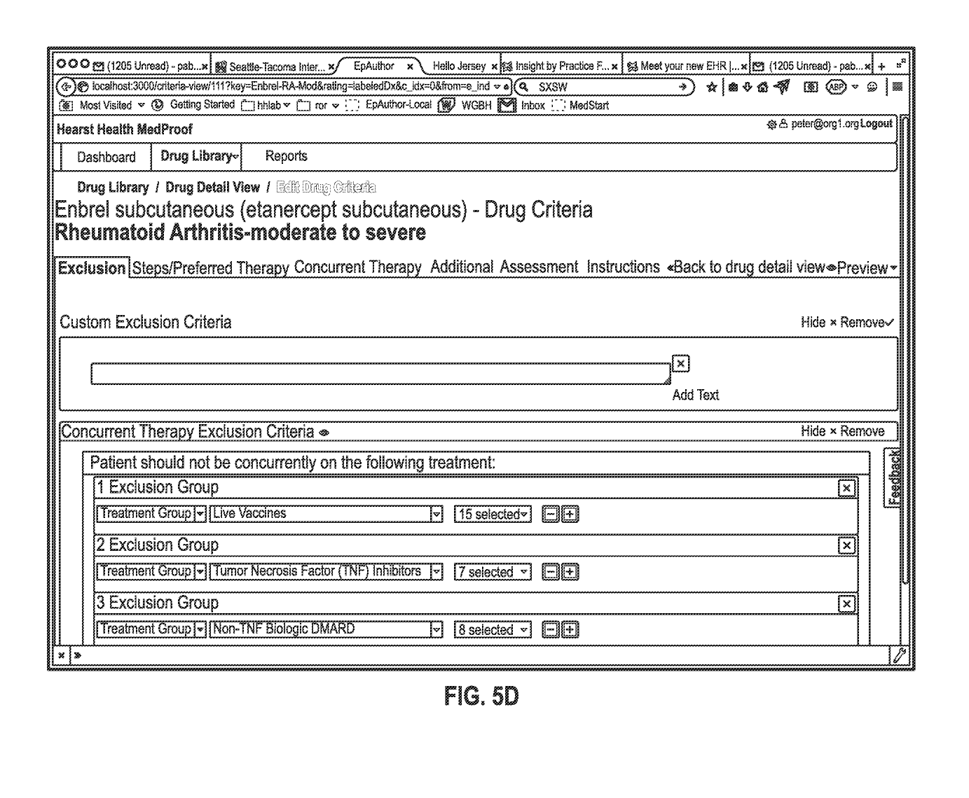

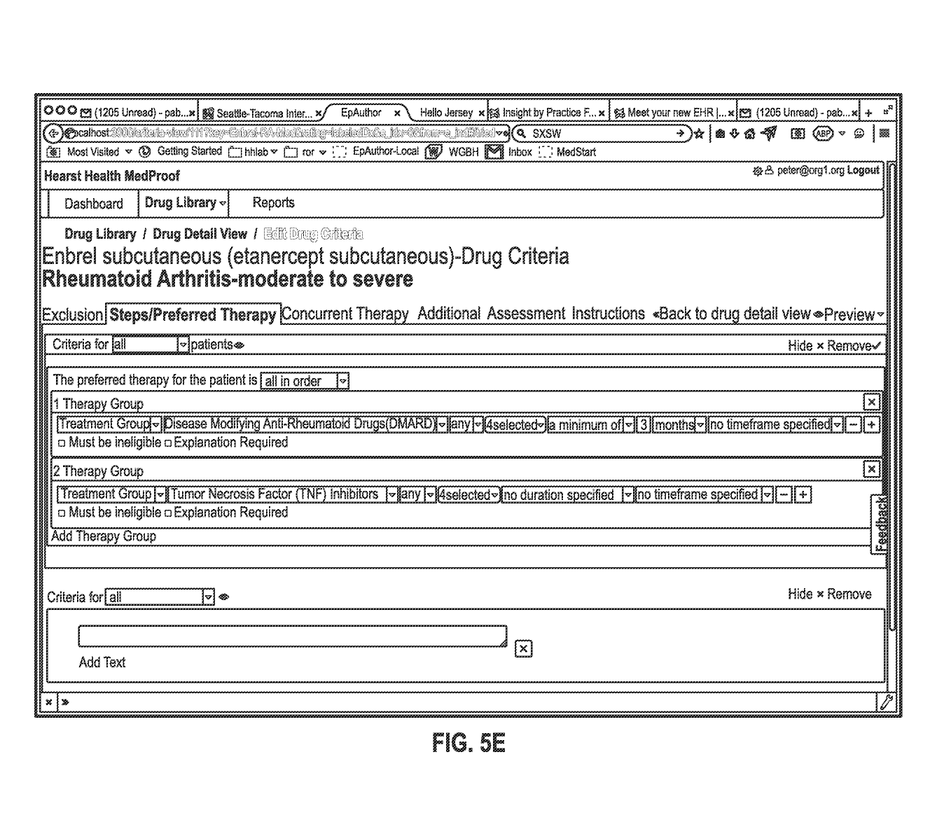

FIG. 2 illustrates an example process for generating a drug criteria object. At block 202, the system generates and provides user interfaces which may be used to by a user (e.g., a pharmacy clinical manager) to provide the information for generating a drug criteria object. Example user interfaces are described in greater detail elsewhere herein with respect to FIGS. 5A-5E. At block 204, the system receives and stores the information entered by the user via the user interfaces. At block 206, a drug prescription authorization rules compiler accesses the stored information and generates executable drug prescription authorization rules. At block 208, a drug criteria object is generated. The drug criteria object may store the executable rules for the drug and other information (e.g., a header, a data dictionary, canonical data, patient data, lists, therapeutic data, and/or other information). At block 210, the system stores the drug criteria object. The system may optionally encrypt the drug criteria object and decrypt the encrypted drug criteria object as needed. The compiler may also be used with rules stored in, and accessed from an already existing drug criteria object. Various aspects of the process will be described in greater detail elsewhere herein.

A criteria object may optionally be portable and may include both rule and input data that may be inspected in multiple host environments that rely on the presence of identical metadata. For example, the criteria object may optionally bundle metadata, canonical values, lists, rules/logic and/or the patient data into a single self-describing data structure which may be utilized and processed by disparate systems operated by different entities.

Thus, optionally the criteria object can be moved from platform to platform or platform to database in one atomic operation. Further, optionally the criteria object can be readied for execution in a single database operation. Yet further, optionally the criteria object captures the rules and their execution state in a form that can be reviewed and repeated even if the current version of the rules has dramatically changed.

Optionally, with reference to FIG. 4, illustrating an example criteria object, the automatically generated rules (in the form of one or more rules structures) are stored in a segment 402 of a corresponding criteria object 400. Optionally, other segments of the criteria object 400 may be used to store a header 401, a data dictionary 404 (e.g. a hierarchical data dictionary), instantiated canonical data 406, instantiated patient data 408 (e.g., demographic data, test result data, treatment history data, current prescriptions, allergies, etc.), instantiated lists 410 used by the rules (e.g., where a list may define a collection of possible values for a concept, and may be used to populate pick lists during authoring, during instantiation of a prior authorization, and/or for evaluation of run-time input against valid values when it is not desirable to display the valid values to the end user), and/or therapeutic alternatives 412.

The header 401 may uniquely identify the criteria object using a code (e.g., where the code is unique across all installations of the system). The header 401 may identify the drug that the criteria object 400 is concerned with (e.g., using the drug's branded and/or generic identifiers in an accepted standard vocabulary system). Additionally, the header 401 may identify the specific routes (indicating how the drug is to be administered), strengths, and/or dosage-forms of the given drug for which the criteria object 400 is valid. The criteria object 400 may store optional criteria for the amounts and timing of initial prescriptions and renewal prescriptions for each indication.

A rule, as defined herein, is a statement that describes a policy or procedure. Rule logic describes the sequence of operations that is associated with data (e.g., stored in a database or other data store) used in evaluating the rule. Evaluation produces a boolean result value that can be the predicate of another rule. Rules can test for one or more of the criteria discussed herein (and/or other criteria), or any combination thereof. Rules can be basic tests for age or gender. For example, certain drugs are not to be prescribed for women and for boys who are prepubescent. Thus, a rule for such a drug may be structured in an inclusive fashion, specifying that it may only be prescribed for men and boys that are post-pubescent. The rule may also be structured so as to be exclusionary. For example, the foregoing rule may be expressed so as to specify that the drug is not to be prescribed for women or for boys who are prepubescent. Other example rules may test for allergies to specific chemical agents, for prior exposure to particular drugs, for prior medical treatments, for prior or current medical conditions, for blood or other clinical tests, for duration on the drug being prescribed or for a previously prescribed drug, etc.

By way of further example, certain types of criteria may, in the form of rules, test whether a patient has first tried and failed to obtain relief or cure on a prescribed set of substitute (e.g., lower costs) therapies. Further, certain criteria may specify that a Preferred/Step Therapy needs to be performed, specifying multiple therapeutic approaches using different drug combinations, where the patient is to try a particular number of these approaches, sometimes in a specified order, in order to be authorized for the therapy/drug in question. For example, Step Therapy may specify that the patient is to try a particular set of therapeutic approaches in a specific order, while Preferred Therapy may specify that the patient is to try a particular set of therapeutic approaches (e.g., of one or more preferred drugs) in no specific order.

Concepts will now be described in greater detail. A concept may define atomic values such as “Date of Birth” or more complex objects such as a prior or preferred/step medication which may have a duration, a strength, unit of measure etc. Optionally, structured concepts and/or their properties can have pick lists of possible valid values. Concepts can optionally be referred to by other parts of the criterion object (e.g., using the function <var ref=concept name /> syntax). Concepts may optionally have static values which are declared in the concept itself. Concepts may optionally have values assigned at the moment of instantiation (for example, the age of a specific patient), in which case the value may be defined in a response object that refers back to the concept. Concepts which have coded values may also state the code system from which the value originates.

A distinction may be made between the concept which a rule may refer to and the rule itself. The concept may be modeled as a hierarchical dictionary whose structure follows the semantic linkage inferred from analysis of the concept domain. For example, comorbidity (the presence of one or more additional disorders (or diseases) co-occurring with a primary disease or disorder; or the effect of such additional disorders or diseases) is a concept that is subservient to a primary indication which a drug may address, and the severity of the comorbidity is subservient to the comorbidity itself.

A rule may include one or more concepts, given canonical values (e.g., a value or a range of specified values), and the canonical values may be tested against the actual value for a given patient. Thus, a rule may express the relationship between concepts. An example, for illustrative purposes, is age. For a given drug and a given indication, a canonical age may be defined as a range extending from 17 to 70 years, wherein the patient needs to be within the canonical age or the prescription pre-authorization approval request will be denied. The rule tests the actual age (a single number) against the canonical age (a range).

A more complex example rule is a rule relating to Preferred/Step Therapy (where the patient is to first try less expensive drugs (e.g., generic version of the drug at issue) or first try another therapeutic approach (e.g. first administer Anticholinergics before trying Angiotensins to treat hypertension) before a prescription will be approved for the drug at issue). Such a rule may have a number of clauses or sub-rules, that when rendered in human language could be expressed as: if the patient has previously been exposed to drugs of class X, has the patient tried at least two of the following therapies: (Drug A with Drug B), (Drug C), (Drug D or Drug E) for at least <some time period> during the last <time frame>.

Optionally, the entire criteria set for a drug may be rendered as a single, complex rule with a single entry point and evaluation path which will encompass all the subsidiary rules which will be evaluated.

Certain example use cases will now be described.

Drug authorization rules touch various members of the health care community performing different roles in different ways. For example, payers (e.g., insurance companies) and their representatives (e.g., pharmacy benefit managers) may create, curate, and publish the rules. Providers (e.g., prescribing medial professions) then need to obtain the correct set of rules for a given patient, drug and health plan. In some cases, pharmacists fulfilling a prescription may need to obtain the correct set of rules at the time of fulfillment. Providers and/or their patient databases need to supply patient data to be input into the rules. For example, the patient data may be input into the rules from an electronic medical record or be input via information obtained by direct observation of the patient by the provider.

The rules may be used by (or on behalf of) various entities. For example, medical adjudicators may use the rules to determine if the information supplied by the provider with respect to a prescription for a patient satisfies at least one complete path through the rule set, so that the prescription prior authorization rules are met, and so the prescription may be approved. By way of illustration, the rule set may be evaluated by the rules engine against structured data, such as that described herein, to verify that at least once complete path has been successful, to thereby provide automated adjudication.

To perform such automated adjudication the rules need to be encoded in a form that can be executed by computer processing.

Conventionally, executable rules are manually created by highly specialized individuals with different skill sets than those who have created the clinical content which the rules represent. Disadvantageously, such a conventional approach suffers from several disadvantages, such as delays in implementation, transcription errors, improperly implemented rules, and the inability for the content originators (e.g., those that entered the formulary criteria) to validate that the rule represents their intention.

However, many challenges need to be overcome in order to provide for automated rule generation. Given the complexity and dependencies of criteria, rules may be very complex. For example, rules may branch, wherein certain rules require satisfaction as a consequence of other rules. Further, rule adjudication should be efficient, so as to reduce processing time and system loading. However, multiple rules may refer to the same concept, and so obtaining a value for a given concept may be expensive in terms of processing time and system usage. Therefore, certain embodiments described herein enable rule evaluation be self-optimizing, where the same information needed for the execution of the rules are not requested multiple times, even if needed by different rule branches.

Still further, clinical expressions can involve interpretation rather than simple comparison, because the concept being tested does not semantically align with the data supplied. By way of example, equivalent textual information may be worded differently (e.g., ACC or Agenesis of the corpus callosum). By way of further example, data may be represented using different coding systems (e.g., ICD-9, ICD-10, CPT, etc.). Certain embodiments described herein are configured to enable the evaluation of such expressions and the accommodation of differing coding systems.

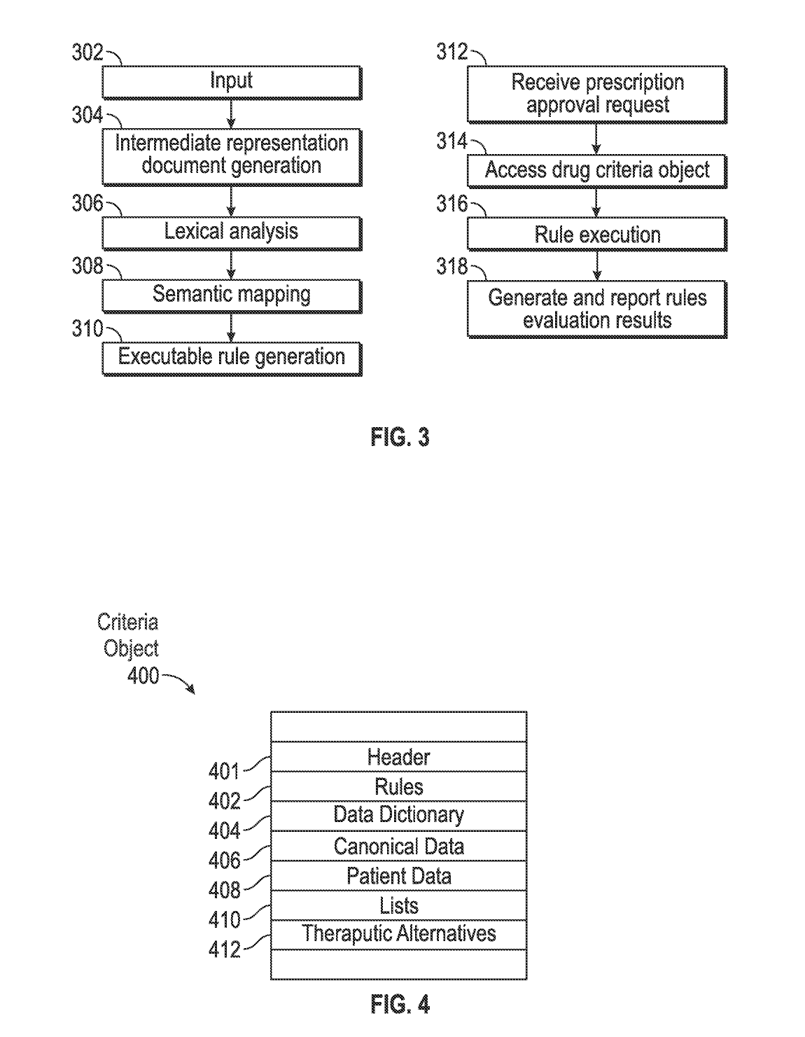

An example compiler configured to automatically generate rules from content provided by a pharmacy clinical manager or other content provider will now be described in greater detail with reference to FIG. 3, which illustrates an example executable rules generation and execution process.

The example process optionally performs some or all of the following. At block 302, the data information for generating a drug criteria object is accessed by the system from a data store, such as data stores 130 or 132. For example, the data information may include information input via the user interface illustrated in FIGS. 5A-5E as similarly discussed with reference to FIG. 2, that are to be used for adjudication of a prescription approval request. At block 304, and as similarly discussed elsewhere herein, the drug criteria may optionally be enumerated by the system in an intermediate document, such as an XML file, a JSON file, other data-interchange format, and/or other language file, as metadata definitions of concepts which will be used in a rule. At block 306, the compiler module may perform lexical analysis (e.g., to convert the XML code into DOM). At block 308, the compiler may verify the syntax and semantics of the source document (e.g., to map inputs to rule predicates, and to generate rules with the correct inputs and condition statements), perform type checking, and generate error messages or warnings as appropriate.

At block 310, the compiler may generate executable rules code for the adjudication of a prescription approval request. For example, the compiler may convert the source file into a sequence of tokens (e.g., keywords, identifiers, constants, punctuation symbols, operator symbols, etc.), perform a syntax analysis to recover the source code structure (e.g., logical data and code structures) using the tokens and to generate a parse tree that illustrates the grammatical structure of the sequence of tokens, perform a semantic analysis using the parse tree and a template containing a data dictionary (e.g., a hierarchical data dictionary) to ensure that each of the concepts referred to in the parse tree correspond to their definitions, and that required data values associated with each concept can be recovered from the parse tree. The example compiler may create a linked network of data structures (e.g., where a data structure contains a pointer to another instance of the same data structure or to a different data structure), that model the evaluation paths and tests determined by the clinical content. The compilation process may be performed in response to a change in criteria object content (e.g., a change detected by the system) or in response to a compilation command from a user. Thus, the compilation may optionally be performed on-the-fly using the latest entered drug information.

At block 1312, a request for a prescription approval is received (e.g., from a prescribing physician system) by the authorization system. At block 1314, the authorization system may access the corresponding drug criteria object from a data store. Optionally, as noted above, the rule compilation may be performed at this time, or prior to the request. At block 1316, a rules engine accesses the executable rules and other criteria object data (e.g., a header, a data dictionary, canonical data, patient data, lists, therapeutic data, and/or other information), and executes the rules using the object data. At block 1318, the results of the rules execution and evaluation are generated and reported (e.g., via a user readable report, via a message communicated to the prescribing physician system, etc.). For example, the evaluation may indicate that the prescription request is to be approved, disapproved, or that additional information is needed (e.g., clinical test results) or that additional steps need to be taken first (e.g., less expensive drugs that need to be taken first as part of preferred/step therapy). Optionally, the process performed in blocks 302-310 may be performed by a different entity and using a different system than the process performed at blocks 1312-1318.

Rules are composed of several basic object types, an Assertion (sometimes referred to as EpAssertion or a derivative thereof), which is a form of branch node, a logical AND structure (sometimes referred to herein as “EpAnd”), a logical OR structure (sometimes referred to herein as “EpOR”), and a Conditional structure (sometimes referred to herein as “EpCondition”). These basic types are assembled into a hierarchical form by the compiler to implement the desired clinical logic. At evaluation time, as control passes through the logical tree, the recursion level of the executing code may become very deep.

An Assertion is a data structure (e.g., a complex data structure) that implements a form of predicate logic. An Assertion, helped by subsidiary And and Or objects, guides the flow of control to specific Condition objects where the evaluation process is performed on granular data elements to determine whether a given patient is eligible for a drug (or other medical treatment) under an insurance plan for which it was authored. Condition objects may also point to subsidiary Assertions which contain further Condition objects. Assertions may act as containers for Condition objects, And objects and/or Or objects, and may roll up a set of inner Boolean values into a single Boolean value.

An assertion structure may optionally be configured to be traversed by a process that enables the display to a provider (e.g., a prescribing physician) of only those concepts which are in need of values in order for an adjudication of the prescription process to be performed. The adjudication process may optionally be fully automated. The assertion structure can be used to enable the generation of a human readable rendering of the evaluation logic (the rules). Optionally, an assertion structure may be recursive in that a given assertion structure may refer to another assertion structure.

The assertion structure may be a container concept which evaluates to either true or false based on the evaluation of its child objects. The example logical AND structure evaluates to true if all of its children evaluate to true. The example logical OR structure evaluates to true if any one of its children evaluate to true. The example Conditional structure tests actual concepts. Assertions can also be the targets of a Condition object, when a rule has uneven depths of recursion. By way of illustration, a Conditional Equals Structure may point to a concept defined in a data dictionary (e.g., a collection of descriptions (e.g., meaning, relationships to other data, origin, usage, format, and/or other descriptions) of the data objects in a data model, optionally in hierarchical form), and may test whether an instantiated canonical value matches an instantiated actual value, optionally accounting for any differences in representation (e.g., range vs. an atomic value). A Conditional Equals Structure evaluates to true or false. By way of further example, Conditional LT (Less Than), LE (Less or Equal To), GE (Greater or Equal To), GT (Greater Than) structures may be used, which all evaluate to true or false. The foregoing structures may point to a concept defined in a data dictionary (e.g., a hierarchical data dictionary) and may respectively test whether an instantiated numeric canonical value is less than, less than or equal to, greater than or equal to or greater than an instantiated actual numeric value for the concept, optionally accounting for any differences in representation. By way of further example, a Conditional Has structure may be used to test whether a canonical group of values for a concept overlaps an actual group of values for the same concept by a pre-determined number of matches. The Conditional Has structure evaluates to true or false. A Conditional Assertion Structure may execute a child assertion and test its return value against a canonical value, evaluates to true or false and may invert the sense of an assertion if needed.

The data dictionary may store descriptions of Concepts. The Concepts are composed of properties and some of these properties may be references to or containers of other concepts. Thus, the data dictionary may be hierarchical. In the example below, the concept triedTherapy has a property ‘patientExposure’ which is defined in a separate concept definition ‘patientHx’. The patientHx's definition, in turn contains, a property ‘exposure’ which is defined in a third concept ‘therapyGroup’, and so on.

<concept name=‘triedTherapy’ compound=‘true’

datatype=‘collection’ label=‘’ alias=‘#{self.name}’>

<property name=‘forDx’ datatype=‘string’ ctype=‘clauseID’/>
<property name=‘numRequired’ datatype=‘string’ list=‘anyof’/>
<property name=‘patientExposure’ datatype=‘object’
ctype=‘patientHx’/>
<property name=‘preferredTherapy’ datatype=‘objset’

ctype=‘therapyGroup’/>

</concept>
.....
<concept name=‘patientHx’ compound=‘true’ datatype=‘collection’

label=‘Prior Therapies or Interventions’ alias=‘#{self.name}’>

<property name=‘forSection’ datatype=‘string’
ctype=‘clauseID’/>
<property name=‘patientHxType’ datatype=‘string’
list=‘patientTypes’/>
<property name=‘exposure’ datatype=‘object’
ctype=“therapyGroup”/>

</concept>

Example modes of rules traversal will now be discussed. The rules structures may comprise a hierarchically arranged network, optionally with a single entry point. Processing of the rules structures may begin with the evaluation of a root assertion and then proceed with an evaluation of the children of that root. The next processing state may depend, at least in part, on the mode of traversal being used. Several example modes will now be described, although other modes may be used.

Adjudication on existing data mode. In this mode, each child is evaluated until:
an evaluation fails and execution is optionally immediately propagated upwards back to the root assertion with the status failure; or
an evaluation fails because the actual data for this condition is missing and no sibling conditions in a parent OR statement can be evaluated. Execution is optionally immediately propagated upwards back to the root assertion with the status incomplete; or
all/any child assertions of the root have evaluated to true.

Interactive Adjudication on existing data mode. In this mode each child is evaluated until:
an evaluation fails and execution is optionally immediately propagated upwards back to the root assertion with the status failure; or
an evaluation fails because the actual data for this condition is missing. Execution is optionally immediately propagated upwards back to the root assertion with the status incomplete. The host system may use the waiting condition to generate a question to elicit the missing data. Optionally, when the missing data is available, execution begins again at the root assertion. Because all needed data is now available up to and including the subject of the latest incomplete test, execution is silent until the next incomplete test is encountered; or
all/any child assertions of the root have evaluated to true.

For a Question List mode, beginning from the root, each child object may be evaluated recursively. Optionally, no condition tests are evaluated, but the actual value for each concept is marked with dummy data as it is encountered so it does not fail. This technique can be used to create lists of questions that describe each aspect of the criteria or a subset thereof (e.g., questions to be supplied to a service provider to answer, such as the prescribing doctor). A data instance may be tested against a class of data.

As discussed elsewhere herein, a user interface may be provided enabling a criteria object for a drug to be defined and/or modified. The user interface may enable a user to specify properties associated with a Concept Diagnosis (e.g., an Indication). For example, the criteria object dictionary may include fields for defining some or all of the following example Concept Diagnosis properties and/or other properties:
A fully qualified name (fqn), which may unambiguously describe in a human language the type of patient (e.g., the medical issue(s)/indication(s) a patient may have), that the drug is suitable for. For example, the fully qualified name may specify that the indication is moderate to severe hypertension;
Disease code(s) of base disease—a ICD-9 code (published by the World Health Organization (WHO)), an ICD-10 code, an International Classification of Procedures in Medicine (ICPM), or other code;
Drug role—what role does drug being prescribed play in therapy (anti-inflammatory, viral suppressant, etc.);
Assessments, such as lab tests, needed to support the prescription, and optionally, the assessment values (or range of values) that the assessments need to return in order for the patient to be eligible for the drug being prescribed;
Rating (e.g., is the drug FDA approved for this specific indication or is it an “off-label” but clinically accepted application for this indication);
Comorbidity (e.g., other indications which are significant for the purposes of authorization of this drug);
Genotype—a genetic variation in the patient or a genetic variation of the infectious agent (e.g., Hepatitis C) causing the condition which would affect the suitability and response of the patient to the drug which is the subject of this authorization;
Polymorphism—specifies a genotypic or phenotypic variation which is relevant to the authorization criteria;
Severity—categorizes the severity of the primary indication according to a standard nomenclature;
   Medical Condition Duration (how long patient has had the current medical condition specified by the indication);
Medication administration quantity limits;
Prescriber requirements;
Clinical references;
Clinical evidence (e.g., results of tests that need to be conducted in order for the patient to be authorized to receive the drug);
Drug application/instructions;
Durations (how long is patient to receive the drug;
Dosing and directions;
Procedural assessments (if required, to prove efficacy, to rule out toxicity, to validate the diagnosis of the required condition or co-morbidity)
Clinical cautions (e.g., clinical cautions of a critical nature, such as contraindications, drug-drug interactions, allergies, other precautions, etc.);
Concurrent therapies (other treatments that are to be applied in conjunction with the drug);
Therapeutic alternatives to this medication (e.g., a generic version of the medication, a less expensive alternative medication, or a less risky medication, etc.).

Further, the following operators may be used with respect to one or more of the above Concept diagnosis properties:
Inclusion (e.g., patient needs to have a certain characteristic in order to be authorized to receive the drug; for example, if the indication is coronary artery disease, a comorbidity object child of that indication may be instantiated, with a specification that it is for diabetes as an inclusion criterion. Thus the entry requirement for this branch of the logic tree is that the patient must have Coronary Artery Disease (CAD) as well as Diabetes);
Exclusion (e.g., characteristics that disqualify patients from receiving a medication);

A criterion object detailed view and/or summary may be generated and presented to a user in a human readable format. For example, the summary may include some or all of the following data and/or other criterion object data (such as other criterion object data discussed herein):

Age requirements

Gender requirement

Preferred/Step therapy (e.g., other medications tried first before “stepping up” to medications that cost more)

Exclusionary criteria (characteristics that disqualify patients from receiving a medication)

Medication administration quantity limits

Prescriber requirements

Clinical references

Clinical evidence

Application/instructions

Durations

Dosing and directions

Procedural assessments

Clinical cautions (e.g., clinical cautions of a critical nature, such as contraindications, drug-drug interactions, allergies, other precautions, etc.)

Concurrent therapy

Therapeutic alternatives to medication

An example process may be performed as follows. A physician may prescribe a certain drug for a patient (Drug X, 60 tablets per month, for 2 months). The formulary (a list of the drugs covered by the prescription drug plan or other insurance plan that offers drug coverage benefits) associated with the patient's insurance policy may specify that prior authorization is required for the prescription. The physician accesses (over a network via a physician terminal) and completes an electronic prior authorization form generated by the system based at least in part on the corresponding prescription authorization criterion object for the drug being prescribed. Optionally, the system accesses patient information over a network from a patient database of the physician and prepopulates at least a portion of the form using such patient information (e.g., name, age, gender, medical history, medical conditions, previously prescribed drugs, currently prescribed other drugs, drug allergies, etc.), and the physician may complete the non-populated fields. Certain patient information may include sensor/lab test readings (e.g., temperature readings, blood pressure readings, pH readings, blood oxygen readings, glucose readings, etc.). The information provided by the system may be stored in a database.

The system rules engine executes rules generated by the system from the corresponding prescription authorization criterion object using the information received via the form. The rules engine determines if the prior authorization request should be approved or rejected, and/or whether additional information, steps, or justification is needed for prescription approval. For example, the prior authorization request may be analyzed and the rules engine may determine that the physician has not followed prior authorization guidelines (e.g., the physician may need to prescribe an alternate drug first for a specified period of time). The system may automatically compose/generate a rejection notification (e.g., an electronic or hardcopy document) and transmit it to the physician. The system may include the rejection reason(s) and the corrective steps that need to be taken (if any are applicable). The rules engine may optionally perform optimized rules execution. The optimization process may ensure that a rule is not re-executed unless a rule input has changed, and may inhibit prompting a user (e.g., a provider) or system to provide a given item of data more than once, even if multiple branches of the rule tree need the given item of data. Thus, the execution optimization may reduce the network and systems bandwidth by avoiding asking for the same data multiple times (even if needed by multiple rule branches). By way of example, the optimization process may generate an indication if a first item of data has already been requested by one rule branch, request and received the first item of data from a data source, detect when the same first item of data is being requested by a second rule branch, and provide the already received first item of data to the second rule branch.

An example automated rules generation process will now be described in greater detail. As discussed above, optionally, the rules are automatically generated substantially immediately after raw criteria data for a drug are received by the system.

As discussed elsewhere herein, rule structures and operators (e.g., EpAssertion, EpCondition, EpAnd, EpOr, etc.) may be used to create a hierarchy of objects, also referred to as an object graph. For example, the system may generate an evaluation tree, where data/facts enter the tree at the top-level nodes as rule parameters, and work their way down the tree if they match the rule conditions. Thus, the Rule tree may be an extension or elaboration of the external form based on the compiler module's ability to determine where each logical element should be placed and how a given element is to be linked to its parents siblings and children. Thus, the object graph will provide multiple pathways from a root node to leaf nodes where actual data tests are performed. Intermediate nodes are waypoints along the route to a leaf node.

Optionally, there is an assertion at the root of the evaluation tree which contains an “OR” of all the possible indications for which this drug has been designated a valid therapy. Thereafter, subordinate assertions, logical operators, and the conditions are generated, optionally on the fly in substantially real time, as the system processes a new drug definition.

As similarly discussed above, EpConditions at leaf nodes test actual concepts. Leaf node conditions optionally may also contain text which may be included in a textual question that is to be asked by the provider if the data to resolve the rule-condition is not already present when the EpCondition evaluation begins (e.g., “Please enter indication” as in Example 2 below, “Please enter patient's gender” as in Example 3 below, “Please enter patient's age” or “Please enter patient's age unit” as in Example 4 below). Optionally, an EpCondition leaf node may include one or more label fields used to assist in debugging. Optionally, an EpCondition leaf node may include a failure message which can be used when compiling an audit report, where the audit report may include the failure message.

In order to further illustrate the techniques described herein, an example illustrative process will now be described for a hypothetical drug that has a simple indication, an age restriction, a gender restriction, and a prior therapy exclusion.

In this example, system has received from a content provider (e.g., a pharmacist) the following “raw” criteria data, and a corresponding template (e.g., an XML template, “cr_template.xml” in this example) is available to the system loading mechanism from a data store. The criteria data may have been entered using one or more user interfaces, such as those illustrated in FIGS. 5D-5E, which simply the criteria specification and editing process, and which reduce errors and the user of inconsistent terminology. The template (e.g., the XML template) is populated by the system using the criteria data. The following is a snippet of an example populated XML template:

<diagnoses>

<diagnosis

<fqn>Well localized neuropathic Pain</fqn>
<age>

<ageRangeType>range</ageRangeType>
<ageRangeMin>15</ageRangeMin>
<ageRangeMax>30</ageRangeMax>
<ageRangeUnit>y</ageRangeUnit>
<ageDesc/>

</age>
<gender>m</gender>
<icd9>12.127</icd9>
<symbolic>neupain</symbolic>

......

<PriorTherapyExclusion>

<criteriaSet>

<excludedTherapy>

<treatment>

<treatmentLine>

<option>OR</option>
<interventionType>group</interventionType>
<codeValues>01.2000</codeValues>
<selectedListName>OPIODS</selectedListName>
<selectedListClassCode>02.1122</selectedListClassCode>
<timeFrame>ly2</timeFrame>
<numRequired>any</numRequired>

</treatmentLine>
<treatmentLine>

<option>WITH</option>
<interventionType>drug</interventionType>
<name>Gabapentin</name>
<codeValues>12.14208</codeValues>
<timeFrame>ly2</timeFrame>

</treatmentLine>

</treatment>

</excludedTherapy>

</criteriaSet>

</PriorTherapyExclusion>
......
</diagnosis>
</diagnoses>

In textual form, this snippet (sometimes referred to as an external specification) is declaring that the drug can be prescribed for male patients between 15 and 30 years of age with a history of well localized neuropathic pain (where the phrase “well localized neuropathic pain” is the fully qualified diagnosis name) who have not be exposed to any drug in the Opiod class during the last two years or to Gabapentin in the last two years. The snippet also specifies a corresponding icd9 code. Tags may be used to define data. The tags may be used in parsing the populated template. In this example, the age range type (“range” in this example) is specified using the tag ageRangeType, the minimum age (“15” in this example) is specified using the ageRangeMin tag, the maximum age (“30” in this example) is specified using the ageRangeMax tag, the age range unit (years “y” in this example) is specified using the ageRangeUnit tag, the gender (male “m” in this example) is specified using the gender tag, an indication identifier (“neupain” in this example) is specified using the symbolic tag, the excluded therapy clause is demarcated using the excludedTherapy tag, etc.

As the above XML snippet is parsed, in-memory objects are created and some or all of the objects may be stored in the criteria object.

An example parsing process will now be described in greater detail. A compiler (e.g., compiler module 122) may load the XML document and may convert the XML document into an XML DOM object. The compiler module (e.g., compiler module 122) loads a document that includes the drug specification. The compiler module may fetch information in a specific order so that structures which have dependencies on other structures will be created after the dependencies themselves are created.

The compiler module instantiates a template (XML template “cr_template.xml” in this example) into a structure (e.g., a Domain Object Model (DOM) which views the XML document as a tree-structure). The compiler module analyzes the concepts found in the template and identifies where concepts make references to a list. For a given reference, the compiler module will create an internal form of the list, and populate it if it finds the definition within the template. As the external XML representation of the drug is parsed, it may find external definitions of a list's contents and use these to populate a list that was referred to but not yet populated in the template. Furthermore, concepts instantiated in the external representation may make reference to completely new lists, for instance groupings of specific drugs that were neither referred to nor defined in the template document. The parsing and compiling mechanism will now instantiate these new lists into the Criteria Object as it imports the instantiated concepts that refer to them. In this manner, the system can accommodate lists that have common contents across all drugs, lists that are semantically aligned across all drugs, but containing different contents for each, and lists that are particular both in function and contents to a specific drug. List objects may be used during authoring, evaluation, and display, to map coded values to human readable statements. For example, the human readable statements may provide a list of acceptable criteria for a given test or other information (human readable form of drug code or diagnoses code).

The compiler module may optionally identify instances of a diagnosis element. For a given diagnosis element, the compiler module may search for and identify members in the set of concept domains in the criteria data document. Some domains are simple concepts such as age or gender, or fqn, the fully qualified human readable form of the indication/diagnosis. Other domains are complex in nature and may have a highly recursive inner structure of sub concepts. When a given domain is populated in the incoming criteria data document, the compiler module may harvest domain details included in the document. For example, the compiler module may optionally invoke a specific function dedicated to harvesting the details of a given populated domain. This process may optionally be recursively performed if the domain details are defined at multiple nesting levels. Such a domain-specific function may generate the in-memory translation, if needed or desired, from the external form as found in the incoming criteria data document to objects and the relationships in their internal form.

As the parsing and compilation process proceeds, domain specific in-memory object will be created. These objects may include Value objects, Rule objects, List objects, and/or other objects. Values and Rules may make reference to Concepts that are defined in the template section of the criteria object. Optionally, if the compiler module determines that an object refers to a concept that has not been defined, the compiler module will generate an error message, which may be reported to a user (e.g., the content author).

In certain optional implementations, where a criteria data document is an external document being imported, the List objects and Value objects may be considered a “direct” importation, in that the internal form optionally has the same semantic intent as its external counterpart.

Rule objects may refer to Concepts (e.g., as defined in the template's “Concepts” section). For a given rule to concept-reference, there may be more than one set of target values. For example, a value can consist of a collection of one or more instances. A given value may be a canonical value or a test value. Thus, in contrast to symbols utilized by conventional compilers, which have a single value, here a given rule symbol may have two or more sets of values.

A canonical value is that which the criteria author sets as the ideal against which the other or “test” value will be compared. Canonical values may be typically set by qualified authors of criteria using the system and form the predicates of the rules that are generated. There are cases where the value types can differ and these may be dealt with as special cases by the evaluation mechanism. For example, the canonical value for age may specify a range and the test value for age may be an atomic numerical or categorical datum that needs fall within that range in order for the rule to be satisfied.

Certain embodiments employ clinical vocabularies in the test of concepts. This approach may reduce ambiguities when canonical data is compared with test data that may arrive in a variety of forms. The use of clinical vocabularies may greatly enhance the computational efficiency of the rules because there are less ambiguities to resolve.

An encoding mechanism of pairs may be used to stipulate a vocabulary system along with a given code and therefore enable a concept to be coded in several vocabularies, optionally substantially simultaneously, or enable a value to be encoded together with its synonyms in the same vocabulary. For example, a code may be specified into segments, including the code of the vocabulary itself, and the code in the vocabulary. Thus, a given coded representation may define the vocabulary and the code itself.

An example rule compilation technique will now be described. The default root assertion node contains a default OR structure (e.g., an “EpOr” node) which may in turn be populated with a collection of assertions that represent indication(s) and/or diagnosis the drug may be used to treat. A diagnosis is the identification of the nature of an illness or other problem by examination of the symptoms, medical history, procedure history and other factors related to the patient. A diagnosis may include one or multiple indications (e.g., a person may have a pneumonia indication and a heart problem indication).

For the example discussed above, a new indication-level assertion is now created referring to the indication aliased as “neupain”. “Neupain” is a symbolic string, which may have been specified by the author as a mnemonic and optionally can have any value. The indication level assertion is the container to an AND statement, where a number of subordinate conditions that test different areas of the criteria will be generated.

These criteria areas are commonly known as domains. Optionally, for a drug to be authorized, all of the populated concept domains of the criteria need to be satisfied. If any domain does not have any criteria supplied by the authors, then optionally that domain is, in essence, ignored. For example, if any domain does not have any criteria supplied by the authors, the domain's rule may be configured to answer in the affirmative. Thus, testing a leaf-level rule whose canonical value is “unspecified” causes the associated rule to evaluate as true.

By way of illustrative example, the domains for a given drug may include some or all of the following and/or other domains (e.g., such as those discussed above with respect to the criteria object dictionary):
Demographics, age, gender, indication, severity comorbidity, genotype, polymorphism;
Prior Therapy Exclusions—drugs and other therapies which if administered to the patient, would render the patient ineligible for the drug in question;
Step Therapy. Drugs and other therapies which either should have been administered to the patient in a specified order, within a specified time period, and not had the desired therapeutic effect, or which the patient is ineligible for based on toxicity, allergy or other documentable reason;
Preferred Therapy. Drugs and other therapies one or more of which either should have been administered to the patient in any order, within a specified time period, and not had the desired therapeutic effect, or which the patient is ineligible for based on toxicity, allergy or other documentable reason;
Concurrent Therapy. Drugs and other therapies which are to be taken together with the requested drug (e.g., because such concurrent therapy is the recommended clinical application). For example, the provider may need to commit to or has prescribed such concurrent therapies prior to the current drug prescription request;
Concurrent Therapy Exclusions. Drugs, which if taken concurrently with some other therapy (e.g., a primary therapy) would cause the authorization for the prescription request of the primary drug to be denied;
Miscellaneous Criteria. An open ended list of criteria, the contents of which may vary as needed according to the drug. Example criteria that may be included in the miscellaneous criteria may include pregnancy status, diet, allergy, BMI (body mass, index), etc.

Example 1 below illustrates an entry point (e.g., a first level branch) of a rules structure generated by compiler that illustrates the use of example domains. It is understood that different domains may be used, and that the domains may be listed in different orders.

An optional generated first condition is a special type, sometimes referred to herein as a EpRuleAction subtype “message”, which may be used to display a text message to a user during the evaluation process. The EpRuleAction subtype “message” condition may always evaluate to true, and so does not take an active role in the adjudication process, but may cause a text message to be displayed to a user in the evaluation workflow.

A second condition, an indication condition, points to an assertion with the key diagnoses.key.neupain. Whatever this assertion returns, will be returned by this condition object.

A third condition, a gender condition, points to an assertion with the key diagnoses.gender.neupain. Whatever this assertion returns, will be returned by this condition object.

A fourth condition, an age range condition, points to an assertion with the key diagnoses.ageRangeType.neupain. Whatever this assertion returns, will be returned by this condition object.

A fifth condition, a therapy exclusion condition, points to an assertion with the key PriorTherapyExclusion.neupain.ac0efd5619b6. The returned value of this assertion will be compared to “false” and the result of the comparison will be returned. Thus, the meaning of the inner assertion will be inverted, so if the assertion passes (i.e., the patient has had the excluded therapy), the condition will fail (and the drug will not be authorized) and vice versa.

With reference to the following examples, the following is a description of various example Object functions and terms, some of which may be optional and others which may be required:
‘alt’, contains the question presented to the end user (may be blank if ctype or vtype are ‘assertion’);
‘var’, contains var.ref, identifying which concept.property is being tested by this condition, var.vtype=assertion if ref is not a concept;
‘operator’, one of (has, has_value, ge, le, eq);
‘constant’, denotes that a single inline value to be tested;
‘label’, describes the test being performed;
‘qlevel’, to store question depth. Will be used to populate an NCPDP question grouping level attribute for the QuestionSet;
‘list’, the name of an internal list to be presented to human user to choose a value from;
‘list_selector’, when not using a defined list, and the list is constructed of a selection of objects at evaluation time;
‘list_display_pair’, when list_selector is in use and we designate which attributes will be label and value presented to user;
‘ctype’, set to ‘assertion’ when the condition points to an assertion instead of a concept, or ‘compound’;
‘or’, when a condition object is the direct parent of other condition objects whose results are to be ‘Orred’ in Boolean logic;
‘and’, when a condition object is the direct parent of other condition objects whose results are to be ‘Anded’ in Boolean logic;
   ‘choices’, when the selection list is hard coded in the condition object;
‘fail’, message to put into the error list when a condition fails;
‘selector’, limits the objects found by var[‘ref’] to those fitting a certain condition;
‘constant.skipnull,’ if there's no canonical or ‘authored value’ skip this evaluation;
List behavior based on presence of ‘Conditionlist’:
   if value is absent and constant. Ctype=self, then look in the concept's metadata for a list name;
   if the value is ‘parent’, then construct a list using all instances of the parent concept;
   if the value is any other value, then it is the name of a list that was created on the fly during drug loading and is not in the template;
   if the list is not defined in the Condition, then constant{ } will contain a definition of the predicate value.

Example 1 further includes identifiers and subordinate assertions (subassertions) discussed in greater detail below, including the following:

“diagnoses.key.neupain,”

“diagnoses.gender.neupain,” and

“diagnoses.ageRangeType.neupain”

### Example 1

{

“dxroot”: “neupain”,
“name”: “diagnoses.neupain”,
“objtype”: “EpAssertion”,
“seq”: 0,
“fail”: “”,
“atype”: “and”,
“clauseID”: “a982cec75e8e”,
“and”: {

“objtype”: “EpAnd”,
“seq”: 0,
“condition”: [

{

“message”: “Demographic Information”,
“type”: “message”,
“objtype”: “EpRuleAction”,
“seq”: 0,
“clauseID”: “4bf77fb4d12d”

}, {

“alt”: “Pointer diagnoses.key: ”,
“label”: “Testing diagnoses.key”,
“ctype”: “assertion”,
“var”: {

“ref”: “diagnoses.key.neupain”

},
“objtype”: “EpCondition”,
“seq”: 0,
“selector”: { },
“clauseID”: “ec0bd6a54d99”

}, {

“alt”: “Pointer diagnoses.gender: ”,
“label”: “Testing diagnoses.gender”,
“ctype”: “assertion”,
“var”: {

“ref”: “diagnoses.gender.neupain”

},
“objtype”: “EpCondition”,
“seq”: 0,
“selector”: { },
“clauseID”: “6a88e0d03708”

}, {

“alt”: “Pointer diagnoses.ageRangeType: ”,
“label”: “Testing diagnoses.ageRangeType”,
“ctype”: “assertion”,
“var”: {

“ref”: “diagnoses.ageRangeType.neupain”

},
“objtype”: “EpCondition”,
“seq”: 0,
“selector”: { },
“clauseID”: “69fd25bf5bl7”

}, {
“alt”: “Pointer PriorTherapyExclusion.neupain.ac0efd5619b6

desired_state: false: ”,

“label”: “Testing
PriorTherapyExclusion.neupain.ac0efd5619b6”,
“var”: {

“ref”:
“PriorTherapyExclusion.neupain.ac0efd5619b6”,
“vtype”: “assertion”

},
“constant”: {

“value”: false

},
“objtype”: “EpCondition”,
“seq”: 0,
“ctype”: “”,
“selector”: { },
“clauseID”: “939f6f269f66”

}

Referring now to example 2, below, the example refers to the concept diagnosis.key, from which the subject and object of the test are derived from, specifies that the “equal” operator should be used, and specifies that the list of legal choices to be displayed is the list of FQNs (Fully Qualified Indication names) and that it will be generated on the fly, as denoted by the reserved list name “parent.” The example includes a subassertion “diagnoses.gender.neupain”. The subassertion name contains the unique identifier “neupain” to distinguish it for the diagnosis tests of other indications.

### Example 2

“name”: “diagnoses.key.neupain”,
“objtype”: “EpAssertion”,
“seq”: 0,
“fail”: “”,

“atype”: “condition”,

“clauseID”: “12620271a6c4”,
“condition”: {

“label”: “Testing indication”,
“alt”: “Please enter indication:”,
“var”: {

“ref”: “diagnoses.key”

},
“operator”: {

“otype”: “eq”

},
“constant”: {

“ctype”: “self”,
“skipnull”: true

},
“selector”: {

“key”: “neupain”

},
“list”: “parent”,
“list_selector”: { },
“list_display_pair”: {

“label”: “fqn”,
“codeValue”: “key”

},
“objtype”: “EpCondition”,
“seq”: 0,
“ctype”: “”,
“clauseID”: “1ec269aa8a49”

}

Referring now to examples 3 and 4, below, an assertion contains an inner condition which refers to the concept diagnosis.gender (from which the subject and object of the test are derived from), which is used to test gender and which specifies that the “equal” operator should be used, and specifies that the list of legal choices to be displayed is a static list defined in metadata for the entry diagnosis.gender defined in the template file (i.e., “gender’).

The example includes a subassertion “diagnoses.ageRangeType.neupain,” which is a compound assertion used to text age, and which contains an inner logical AND structure “EpAnd’. The Conditions contained within the AND structure are generated in response to the value of ageRangeType (age range) supplied by the author. In this example the type value is “range,” the ageMin (minimum age) is 15, the ageMax (maximum age) is 30, and the ageUnit (age units) is years.

Given these inputs, the compiler generates a first inner condition that refers to an actual age concept (e.g., diagnoses.ageActual), an operator type range, and a target min and max value compiled into the expression (which may be present in the canonical value collection). A second inner condition refers to the concept diagnoses.ageRangeUnit, an operator “equals,” and a static list supplied by the metadata for the entry diagnoses.ageRangeUnit (i.e., “timeunit”). Among the conditions included in the diagnosis or indication assertion is a condition that points to PriorTherapyExclusion for this diagnosis (see, e.g., example 5 below).

With reference to example 5 (Diagnosis Pointer To Prior Therapy Exclusion), because this is an exclusion test, and as similarly discussed above, an exclusion test may be an assertion that is compared to the value false, where if the assertion returns true, the authorization of the parent drug is denied.

### Example 3 Subassertion 2

### Testing Gender

{

“name”: “diagnoses.gender.neupain”,
“objtype”: “EpAssertion”,
“seq”: 0,
“fail”: “”,
“atype”: “condition”,
“clauseID”: “10ec4ebe11fd”,
“condition”: {

“label”: “Testing gender”,
“alt”: “Please enter patient’s Gender”,
“var”: {

“ref”: “diagnoses.gender”

},
“operator”: {

“otype”: “eq”

},
“constant”: {

“ctype”: “self”,
“skipnull”: true

},
“list”: “gender”,
“selector”: {

“key”: “neupain”

},
“objtype”: “EpCondition”,
“seq”: 0,
“ctype”: “”,
“clauseID”: “e2cf8ba02b53”

### Example 4 Subassertion 3

### Testing Age Range and AgeUnit

{

“name”: “diagnoses.ageRangeType.neupain”,
“compound”: “true”,
“objtype”: “EpAssertion”,
“seq”: 0,
“fail”: “”,
“atype”: “and”,
“clauseID”: “21e3c8441396”,
“and”: {

“objtype”: “EpAnd”,
“seq”: 0,
“condition”: [

{

“label”: “Testing age”,
“alt”: “Please enter patient’s age”,
“var”: {

“ref”: “diagnoses.age Actual”

},
“operator”: {

“otype”: “range”

},
“constant”: {

“minvalue”: “15”,
“maxvalue”: “30”

},
“selector”: {

“key”: “neupain”

},
“objtype”: “EpCondition”,
“seq”: 0,
“ctype”: “”,
“clauseID”: “7f18f117f565”

}, {

“label”: “Testing age unit”,
“alt”: “Please enter patient’s age unit”,
“var”: {

“ref”: “diagnoses.ageRangeUnit”

},
“operator”: {

“otype”: “eq”

},
“constant”: {

“ctype”: “self”,
“skipnull”: true

},
“selector”: {

“key”: “neupain”

},
“objtype”: “EpCondition”,
“seq”: 0,
“ctype”: “”,
“clauseID”: “764c67610776”

}

]

}

}

### Example 5

### Diagnosis Pointer To PriorTherapy Exclusion

“alt”: “Pointer PriorTherapyExclusion.neupain.ac0efd5619b6

desired_state: false: ”,

“label”: “Testing
PriorTherapyExclusion.neupain.ac0efd5619b6”,
“var”: {

“ref”: “PriorTherapyExclusion.neupain.ac0efd5619b6”,
“vtype”: “assertion”

},
“constant”: {

“value”: false # This flips the logic of the assertion

},
“objtype”: “EpCondition”,
“seq”: 0,
“ctype”: “”,
“selector”: { },
“clauseID”: “939f6f269f66”

}

Referring to example 6 (Prior Therapy Exclusion Assertion Pointer to Therapy Group), a first nesting level of the PriorTherapyExclusion domain is an assertion, referred to as a CriteriaSet, that contains a logical OR structure and a set of subordinate conditions, each pointing to a unique assertion known as a TherapyGroup. If any of the subordinate conditions return “true,” then the parent assertion will return true and therefore the drug prior authorization request will fail. As noted above, Condition objects may point to subsidiary assertions which contain further condition objects. Assertions may act as containers for Condition objects, And objects and/or Or objects, and may roll up a set of inner Boolean values into a single Boolean value. For example, all the subservient aspects of each Therapy Group may roll up to a Boolean at the TherapyGroup level, which in turn rolls up to a Boolean Assertion at the Criteria Set level.

The CriteriaSet assertion in this example is a re-usable object that is found in the following domains: Step Therapy, PriorTherapyExclusion, ConcurrentTherapy and ConcurrentTherapyExclusion. A CriteriaSet Assertion groups a set of distinct therapies, together with a patient cohort. In particular, the CriteriaSet Assertion defines a set of therapies that the patient must or must not have tried (depending on domain) if they are a member of the cohort.

Optionally, the PriorTherapyExclusion and ConcurrentTherapyExclusion domains typically have only one instance of a Criteria Set because they have only one cohort: “All Patients”. By comparison, optionally, the StepTherapy and ConcurrentTherapy domains can have any number of such CriteriaSets, depending on which cohorts have been called out by the authors as relevant stratification of the patient population. The Cohort or Patient History assertion is discussed in greater detail elsewhere herein.

As the PriorTherapyExclusion domain has only one CriteriaSet, there is no associated PatientHistory object.

Referring now to example 7 (Therapy Group Assertion pointing to TreatmentGroup), the example will now be discussed with respect to an illustrative PriorTherapyExclusion.neupain.ac0efd5619b6.criteriaset.63391. A TherapyGroup Assertion models the test of a therapy alternative that can contain one or more individual drugs meant to be taken together. Since there can exist alternatives to a drug component of a TherapyGroup, groupings of individual drugs connected by AND, OR or WITH constructs are permitted.

A given drug component is modeled as derivation of the Assertion object, referred to herein as a TreatmentGroup. TreatmentGroups, are gathered together under the TherapyGroup Assertion in groups nested as And/Or groups. For example:

Therapy GroupAssertion
AND
   OR
      DRUG A TreatmentGroupAssertion
      DRUG B TreatmentGroupAssertion
   DRUG C TreatmentGroupAssertion

The foregoing Therapy Group assertion will evaluate such that either A or B needs to be satisfied and C must be satisfied

In the example PriorTherapyExclusion assertion, this level of nesting is not needed since the presence of any of the listed drugs will trigger an exclusion. Therefore, in the authoring mechanism (e.g., the XML authorizing system), optionally only a logical OR structure is allowed, and a typical therapy group would just contain a set of logical ORed Treatment LineAssertions. The following is an illustrative example:

Therapy GroupAssertion:
OR
   DRUG A TreatmentGroupAssertion
   DRUG B TreatmentGroupAssertion
   DRUG C TreatmentGroupAssertion

### Example 7

### Therapy Group Assertion pointing to TreatmentGroup

{

“name”:

“PriorTherapyExclusion.neupain.ac0efd5619b6.criteriaset.63391”,

“objtype”: “EpTherapyGroup”,
“seq”: 0,
“fail”: “”,
“compound”: “false”,
“atype”: “and”,
“clauseID”: “d44ee4112f6f”,
“and”: {

“objtype”: “EpAnd”,
“seq”: 0,
“condition”: [

{

“ctype”: “assertion”,
“alt”: “treatments”,
“var”: {

“ref”:

“PriorTherapyExclusion.neupain.ac0efd5619b6.criteriaset.63391.tg”

},
“seq”: 0,
“objtype”: “EpCondition”,
“label”: “”,
“selector”: { },
“clauseID”: “004573bc3a44”

}

]}

}

An example TreatmentGroup Assertion models a logical ANDed combination of a Treatment Line Assertion and an optional TreatmentInterventionLine Assertion. The TreatmentGroup Assertion contains conditions pointing to an instance of each of the Assertion constructs. Example 8 is an illustrative example, of a treatment group assertion model.

### Example 8

### Treatment Group Assertion Pointer

},

{

“name”:

“PriorTherapyExclusion.neupain.ac0efd5619b6.criteriaset.63391.tg”,

“objtype”: “EpTreatmentGroup”,
“seq”: 0,
“fail”: “”,

“atype”: “and”,

“clauseID”: “bc5cfe9264c7”,
“and”: {

“objtype”: “EpAnd”,
“seq”: 0,
“condition”: [

{

“var”: {

“ref”: “321520571d9a”

},
“ctype”: “assertion”,
“seq”: 0,
“alt”: “Pointer to WITH”,
“objtype”: “EpCondition”,
“label”: “”,
“selector”: { },
“clauseID”: “8218672c0e07”

}

]}

},

A given group models a specific component of a therapy. For example, a given group (e.g., Treatment Lines) may be oriented to a medication component of a therapy, and another the optional group (e.g., InterventionLine) may model a concurrent procedure, test or other intervention that that needs to be supplied. Optionally, a TreatmentLine may refer only to a required intervention as a component of a preferred/step therapy, so that in this TherapyGroup there may be no drug component specified. The AND container in the example above, has only a single Condition pointing to a Treatment Line for illustrative purposes, although multiple conditions may be used.

In particular, a Treatment Line Assertion is where parameters of a drug component (e.g., a single drug component) are compared with the actual patient's exposure. The Treatment Line Assertion contains a set of leaf-conditions which tests the drug, exposure duration and exposure timeframe. The drug identity may be tested using the codeValue of the drug.

There may be multiple varieties of Treatment Line assertions. For example, one type of Treatment Line assertion may model a single drug, and another type of Treatment Line assertion may model a class or group of drugs which may or may not be equivalent.

Example 9 provides an example Treatment Line assertion with attribute testing.

### Example 9

{

“seq”: 0,
“compound”: “true”,
“objtype”: “EpTreatment Line”,
“fail”: “”,
“atype”: “and”,
“clauseID”: “321520571d9a”,
“name”: “321520571d9a”,
“and”: {

“objtype”: “EpAnd”,
“seq”: 0,
“condition”: [

{

“alt”: “Intervention”,
“var”: {

“ref”: “Treatment Line.codeValue”

},
“selector”: {

“tlClause”: “321520571d9a”

},
“operator”: {

“otype”: “has”,
“min”: “any”

},
“choices”: {

“choice”: “01.2000”

},
“list”: “OPIODS”,
“list_display_pair”: {

“label”: “name”,
“codeValue”: “codeValue”

},
“objtype”: “EpCondition”,
“seq”: 0,
“ctype”: “”,
“label”: “”,
“clauseID”: “26a02730736d”

}, {

“alt”: “For”,
“var”: {

“ref”: “Treatment Line.dur”

},
“selector”: {

“tlClause”: “321520571d9a”

},
“operator”: {

“otype”: “”

},
“constant”: {

“datatype”: “numeric”,
“value”: “”,
“skipnull”: true

},
“objtype”: “EpCondition”,
“seq”: 0,
“ctype”: “”,
“label”: “”,
“clauseID”: “fcf4232422d8”

}, {

“alt”: “Time Unit”,
“var”: {

“ref”: “Treatment Line.durUnit”

},
“selector”: {

“tlClause”: “321520571d9a”

},
“operator”: {

“otype”: “eq”

},
“constant”: {

“datatype”: “string”,
“value”: “”,
“skipnull”: “true”

},
“list”: “durunits”,
“objtype”: “EpCondition”,
“seq”: 0,
“ctype”: “”,
“label”: “”,
“clauseID”: “1f0b3c5ae616”

}, {

“alt”: “Timeframe”,
“var”: {

“ref”: “Treatment Line.timeFrame”

},
“selector”: {

“tlClause”: “321520571d9a”

},
“list”: “timeframe_responses”,
“operator”: {

“otype”: “eq”

},
“constant”: {

“datatype”: “string”,
“value”: “ly2”,
“skipnull”: “true”

},
“objtype”: “EpCondition”,
“seq”: 0,
“ctype”: “”,
“label”: “”,
“clauseID”: “4d15a616fc2b”

}

```
  ]
  }
}
```

]}

}

Patient cohort rules will now be described. StepTherapy and the ConcurrentTherapy concepts may include a Patient History object. The Patient History object wraps an assertion that tests whether the current patient is in a specific cohort based on prior drugs they may have been or not been exposed to.

For example, the Patient History object may be in the form of a compound assertion including an AND and inner Condition structures (e.g., two inner condition structures).

By way of example, a Patient History object may include:

1. A test of the Cohort Type Name

a. A reference to the patientHx.patientHxType Concept

b. An equal Operator (“eq”)

c. An Implicit reference to the list of patient types (“patientTypes”) defined in the Concept

2. A test of clinical exposures (“ClinicalExposures”), if any, which accompany the cohort type. Thus, for example, if the cohort selected is “partialResponder” then the clinical exposure defines the prior therapy which the patient has or is partially responding to.

With reference to FIGS. 5A-5E, certain example user interfaces will now be described. The user interfaces described herein can be implemented as a graphical user interface (GUI), web-based user interface, computer program, smartphone or tablet program or application, touchscreen, command line interface, gesture, voice, or text interface, etc., or any combination thereof.

Referring to FIG. 5A, a partial listing a drug library/criterion object library is provided via a drug library user interface, which may be generated by the system 102. The data displayed via the user interface may be populated from data accessed from a data store, such as the criteria object data store 130 or the client customized criteria objects data store 132. The user interface includes a search query via which the user can enter one or more search queries (e.g., using a keyword, a drug brand name, a drug generic name, a drug class, an indication, a status, an update period, etc.). One or more filter controls are provided via which the user can filter the search results (e.g., a master filter, a new and updated drug entry filter, a drug entry still undergoing a review process, a drug entry in progress, all published drug entries, etc.). The drug listing may include multiple fields for a given drug entry, such as brand name, generic name, TX (taxonomy) class, indications, status, update date and update author. One or more of the fields may include links to additional information related to the field. One or more of the fields may be configured to detect that a user is hovering a pointing device/cursor over the field and may display additional related information (e.g., in a pop-up window, in a side window, or otherwise).

FIGS. 5B-5C illustrate an example user interface displayed in response to a user selecting a field link from a field illustrated in FIG. 5A. The data displayed via the user interface may be populated from data accessed from a data store, such as the data stores 130, 132. In this example, the user has selected the indications link for the drug Enbrel subcutaneous. The indications user interface illustrated in FIGS. 5B-5C is configured to provide such indications as an applicable medical condition for which the drug is authorized (e.g., rheumatoid Arthritis-moderate to severe). The user interface further provides age, gender, and prescriber criteria (e.g., age at least 18 years old, gender not specified, prescriber rheumatologist), initial duration data, renewal duration data, and maximum duration data. The user interface further provides exclusion criteria, step/preferred therapy criteria, and concurrent therapy data. In addition, the user interface provides dosing and directions, including alternatives, and quantity limits. The user interface also provides detailed information about the drug, including brand name, generic name, a textual statement as to the drug class, strength and form information, etc.

FIGS. 5D-5E illustrate example user interface that enables a user (e.g., a content author) to create or edit criteria or other data for a drug criteria object. The user entries, selections, and/or edits may be stored in a data store (e.g., data store 130) for later retrieval. There are various tabs, which when selected, cause corresponding editing user interfaces to be presented. In this example there are tabs, and corresponding editing user interfaces, for exclusion criteria, step/preferred therapy criteria, concurrent therapy criteria, additional criteria, assessment criteria, and instructions. Optionally, the various editing user interfaces, and their respective fields, may be combined in a single user interface or may be otherwise combined. FIG. 5D illustrates an example exclusion criteria user interface for the drug discussed above with respect to the user interfaces illustrated in FIGS. 5A-5C. The fields include a custom exclusion criteria field configured to receive custom exclusion criteria from a user (e.g., via a text input). In addition, the user can add one or more exclusion groups specifying which treatments the patient should not be concurrently receiving, where the user can select the treatment specifier type (e.g., treatment group if there is a list of drugs that are acceptable members of this component, or just “drug” if there is only a single drug which is acceptable) and excluded treatment for the group (e.g., live vaccines, tumor necrosis factor (TNF) inhibitors, non-TNF Biologic DMARD, etc.). In this example, 15 drugs are selected.

FIG. 5E illustrates an example concurrent therapy criteria editing user interface via which the user can specify to which types of patients (the patient cohort) (e.g., all patients, naïve patients (patients that have not been treated for disease with any drug of interest), partial responder (patient group that only partially responded to some other specified drug), non-responder (patient group that did not respond to some other specified drug)), the applicable concurrent therapies, the preferred therapies (e.g., specific drugs or classes of drugs) and optionally the preferred order of therapies (e.g., a preferred/step therapy) the patient needs to have tried in order to be eligible to receive drug. For example, the user can add one or more therapy groups specifying which treatments the patient should concurrently receive and for how long the patient should receive the therapy group, where the user can select the therapy group type and the concurrent treatment for the group. By way of further example, the user can specify that a patient needs to be ineligible for one or more specified alternative drugs/step therapies (e.g., because the patient is allergic or otherwise does not qualify to receive the alternative drug), in order to be eligible for the prescribed drug.

Thus, techniques disclosed herein provide for more efficient, less error prone, and more comprehensive generation of prescription approval rules, and for the review and approval processes for medical treatment prescriptions.

The methods and processes described herein may have fewer or additional steps or states and the steps or states may be performed in a different order. Not all steps or states need to be reached. The methods and processes described herein may be embodied in, and fully or partially automated via, software code modules executed by one or more general purpose computers. The code modules may be stored in any type of computer-readable medium or other computer storage device. Some or all of the methods may alternatively be embodied in whole or in part in specialized computer hardware. The systems described herein may optionally include displays, user input devices (e.g., touchscreen, keyboard, mouse, voice recognition, etc.), network interfaces, etc.

The results of the disclosed methods may be stored in any type of computer data repository, such as relational databases and flat file systems that use volatile and/or non-volatile memory (e.g., magnetic disk storage, optical storage, EEPROM and/or solid state RAM).

The various illustrative logical blocks, modules, routines, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

Moreover, the various illustrative logical blocks and modules described in connection with the embodiments disclosed herein can be implemented or performed by a machine, such as a general purpose processor device, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor device can be a microprocessor, but in the alternative, the processor device can be a controller, microcontroller, or state machine, combinations of the same, or the like. A processor device can include electrical circuitry configured to process computer-executable instructions. In another embodiment, a processor device includes an FPGA or other programmable device that performs logic operations without processing computer-executable instructions. A processor device can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor device may also include primarily analog components. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, routine, or algorithm described in connection with the embodiments disclosed herein can be embodied directly in hardware, in a software module executed by a processor device, or in a combination of the two. A software module can reside in RAM memory, flash memory, ROM memory, EPROM memory, EEPROM memory, registers, hard disk, a removable disk, a CD-ROM, or any other form of a non-transitory computer-readable storage medium. An exemplary storage medium can be coupled to the processor device such that the processor device can read information from, and write information to, the storage medium. In the alternative, the storage medium can be integral to the processor device. The processor device and the storage medium can reside in an ASIC. The ASIC can reside in a user terminal. In the alternative, the processor device and the storage medium can reside as discrete components in a user terminal.

Conditional language used herein, such as, among others, “can,” “may,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without other input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone application, computer application, a short messaging service message (e.g., SMS, MMS, etc.), instant messaging, email, push notification, audibly, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, voice recognition, etc.), network interfaces, etc.

While the above detailed description has shown, described, and pointed out novel features as applied to various embodiments, it can be understood that various omissions, substitutions, and changes in the form and details of the devices or algorithms illustrated can be made without departing from the spirit of the disclosure. As can be recognized, certain embodiments described herein can be embodied within a form that does not provide all of the features and benefits set forth herein, as some features can be used or practiced separately from others. The scope of certain embodiments disclosed herein is indicated by the appended claims rather than by the foregoing description. All changes which come within the meaning and range of equivalency of the claims are to be embraced within their scope.

What is claimed is:

1. A system configured to generate prior authorization drug request rules, the system comprising:
a computer data repository that stores drug prior authorization criteria for a plurality of drugs; and
a computing system comprising one or more computing devices, said computing system programmed to implement:
a user interface generation module configured to generate a criteria specification user interface configured to enable a user to specify at least exclusion criteria, inclusion criteria, preferred or step therapy criteria, concurrent therapy criteria, assessment criteria, quantity limits, and refill instructions;
a prescription prior authorization rules compiler module configured to access a criteria specification for the drug from the computer data repository and to automatically compile the criteria specification into executable prescription prior authorization rules configured to be executed by a prescription prior authorization rules evaluation engine;
a rendering module configured to generate human readable prescription criteria from canonical data included in the criteria specification;
a drug criteria object generation module configured to generate a drug criteria object for the drug, including drug criteria object identification information, the executable prescription prior authorization rules, a data dictionary, and canonical data;
a search engine configured to search a drug criteria object library in response to a user search query, the user search query including a drug name, an indication, a therapeutic class, or a drug code.

2. The system for generating prior authorization drug request rules as defined in claim 1, wherein the drug criteria object generation module is configured to generate a self-contained drug criteria object that comprises sufficient metadata to enable the self-contained drug criteria object to be validated for internal consistency without reference to outside metadata sources.

3. The system for generating prior authorization drug request rules as defined in claim 1, wherein the drug criteria object generation module is configured to generate a header that includes:
a unique drug criteria object code; and
specific routes indicating how the drug is to be administered,
drug strength, and drug dosage-form,
for which the drug criteria object is valid.

4. The system for generating prior authorization drug request rules as defined in claim 1, wherein the drug criteria object further comprises a link to clinical evidence.

5. The system for generating prior authorization drug request rules as defined in claim 1, wherein the system is configured to enumerate the criteria specification for the drug in an intermediate data-interchange format document as metadata definitions of concepts which will be used in a rule.

6. The system for generating prior authorization drug request rules as defined in claim 1, the system is configured to enumerate the criteria specification for the drug in an intermediate data-interchange format document as metadata definitions of concepts which will be used in a rule, wherein the compiler is configured to examine syntax and semantics of the intermediate document and to map inputs to rule predicates.

7. The system for generating prior authorization drug request rules as defined in claim 1, wherein the computing system is further programmed to implement a drug criteria object customization module enabling a user to customize the drug criteria object and to store the customized drug criteria object in association with an account of a first entity.

8. The system for generating prior authorization drug request rules as defined in claim 1, further comprising the prescription prior authorization rules evaluation engine, wherein the prescription prior authorization rules evaluation engine is configured to traverse rule structures.

9. The system for generating prior authorization drug request rules as defined in claim 1, further comprising the prescription prior authorization rules evaluation engine, wherein the prescription prior authorization rules evaluation engine is configured to indicate that the prescription prior authorization request is to be approved, or disapproved, or that additional information is needed, or that additional steps need to be taken first prior to approval of the prescription prior authorization request.

10. A computerized method for generating prior authorization drug request rules, the method comprising:
providing by a computer system comprising hardware for display on a user terminal, a user interface comprising a plurality of fields, the plurality of fields configured to receive information regarding a first drug, including at least prescription prior approval criteria for approving a prescription of the first drug, wherein the user interface enables a user to specify inclusion criteria, exclusion criteria, concurrent therapy criteria, and preferred or step therapy criteria;
receiving and storing at the computer system prescription prior approval criteria for the first drug specified using the user interface;
compiling by the computer system the prescription prior authorization approval criteria into executable prescription prior authorization approval rules code without a user manually coding the executable prescription prior authorization approval rules code;
generating by the computer system a self-contained drug criteria object, the self-contained drug criteria object comprising at least:
identification information indicating which drug, route, strength, and dosage forms the self-contained drug criteria object refers to,
the executable prescription prior authorization approval rules code, a hierarchical data dictionary,
canonical data instantiating concepts of the hierarchical data dictionary, and
a unique identifier;
storing by the computer system the self-contained drug criteria object in non-transitory memory;
providing by the computer system a prescription prior authorization approval rules engine with access to the stored self-contained drug criteria object for execution.

11. The computerized method for generating prior authorization drug request rules as defined in claim 10, the method further comprising:
receiving a request for pre-approval of a first prescription for the first drug;
accessing stored the self-contained drug criteria object;
accessing patient data associated with the first prescription pre-approval request;
executing, using the prescription prior authorization approval rules engine, the executable prescription prior authorization approval rules code;
providing an indication as to whether the first prescription request is approved or disapproved;
automatically translating the self-contained drug criteria object into one or more external electronic message representations compatible with industry standards;
automatically translating the self-contained criteria object contents into one or more printable or electronically presentable forms corresponding to manually authored counterparts currently in use by a medical service-related community.

12. The computerized method for generating prior authorization drug request rules as defined in claim 10, the method further comprising generating a human readable intermediate document using a lightweight data-interchange format, the intermediate document comprising metadata definitions of concepts used in one or more prescription prior authorization approval rules.

13. The computerized method for generating prior authorization drug request rules as defined in claim 10, the method further comprising enumerating the prescription prior approval criteria in an intermediate data-interchange format document as metadata definitions of concepts which will be used in a rule, wherein the compiler examines the intermediate document and maps inputs to rule predicates.

14. The computerized method for generating prior authorization drug request rules as defined in claim 10, wherein the generated self-contained drug criteria object further comprises:
a fully qualified diagnosis;
a disease code;
a drug role;
assessments needed to support approval of the prescription;
inclusion criteria;
medical condition criteria;
therapeutic alternatives; and
links to clinical references.

15. The computerized method for generating prior authorization drug request rules as defined in claim 10, wherein the self-contained drug criteria object further comprises:
a fully qualified diagnosis;
a disease code;
a drug role;
assessments needed to support approval of the prescription;
inclusion criteria;
medical condition criteria; and
therapeutic alternatives.

16. The computerized method for generating prior authorization drug request rules as defined in claim 10, wherein the self-contained drug criteria object further comprises a header including:
a unique drug criteria object code; and
specific routes indicating how the drug is to be administered,
drug strength, and
drug dosage-form,
for which the self-contained drug criteria object is valid.

17. The computerized method for generating prior authorization drug request rules as defined in claim 10, the method further comprising:
providing a user interface enabling a first entity to customize the self-contained drug criteria object;
receiving a customization of the self-contained drug criteria object;
storing the customized self-contained drug criteria object in association with an account of the first entity.

18. A computer storage system comprising a non-transitory storage device, the computer storage system having stored thereon executable program instructions that direct a computer system to at least:
provide, for display on a user terminal, a user interface comprising a plurality of fields, the plurality of fields configured to receive information regarding a first drug, including at least prescription prior approval criteria for approving a prescription of the first drug, wherein the user interface enables a user to specify inclusion criteria, exclusion criteria, concurrent therapy criteria, and preferred or step therapy criteria;
receive and store prescription prior approval criteria for the first drug specified using the user interface;
compile the prescription prior authorization approval criteria into executable prescription prior authorization approval rules code;
generate a drug criteria object, the drug criteria object comprising at least:
identification information indicating which drug, route, strength, and dosage forms the drug criteria object refers to,
the executable prescription prior authorization approval rules code, a hierarchical data dictionary, and
a unique identifier;
store the drug criteria object in non-transitory memory;
provide a prescription prior authorization approval rules engine with access to the stored drug criteria object for execution.

19. The computer storage system as defined in claim 18, wherein the executable program instructions further direct the computer system to:
receive a request for pre-approval of a first prescription for the first drug;
access stored the drug criteria object;
accessing patient data associated with the first prescription pre-approval request;
execute, using the prescription prior authorization approval rules engine, the executable prescription prior authorization approval rules code;
provide an indication as to whether the first prescription request is approved or disapproved; and
automatically translate the drug criteria object into one or more external electronic message representations compatible with industry standards.

20. The computer storage system as defined in claim 18, wherein the executable program instructions further direct the computer system to enumerate the prescription prior approval criteria in an intermediate data-interchange format document as metadata definitions of concepts which will be used in a rule, wherein the compiler examines the intermediate document and maps inputs to rule predicates.

21. The computer storage system as defined in claim 18, wherein the generated drug criteria object further comprises:
a fully qualified diagnosis;
a disease code;
a drug role;
assessments needed to support approval of the prescription;
inclusion criteria;
medical condition criteria;
therapeutic alternatives; and
links to clinical references.

22. The computer storage system as defined in claim 18, wherein the generated drug criteria object further comprises:
a fully qualified diagnosis;
a disease code;
a drug role;
assessments needed to support approval of the prescription;
inclusion criteria;
medical condition criteria;
therapeutic alternatives; and
links to clinical references.

23. The computer storage system as defined in claim 18, wherein the drug criteria object further comprises:
a fully qualified diagnosis;
a disease code;
a drug role;
assessments needed to support approval of the prescription;
inclusion criteria;
medical condition criteria; and
therapeutic alternatives.

24. The computer storage system as defined in claim 18, wherein the drug criteria object further comprises a header including:
a unique drug criteria object code; and
specific routes indicating how the drug is to be administered,
drug strength, and
drug dosage-form,
for which the drug criteria object is valid.

25. The computer storage system as defined in claim 18, wherein the executable program instructions further direct the computer system to:
provide a user interface enabling a first entity to customize the drug criteria object;
receive a customization of the drug criteria object;
store the customized drug criteria object in association with an account of the first entity.
